(19) United States
(12) Patent Application Publication
(10) Pub. No.: US 2026/0116794 A1
(43) Pub. Date: Apr. 30, 2026

(54) OZONE OXIDATIVE PRECIPITATION OF ELEMENTS FROM AQUEOUS STREAMS

(71) Applicant: THE PENN STATE RESEARCH FOUNDATION, University Park, PA (US)

(72) Inventors: Mohammad REZAEE, University Park, PA (US); Younes SHEKARIAN, University Park, PA (US); Sarma PISUPATI, University Park, PA (US)

(21) Appl. No.: 19/036,687

(22) Filed: Jan. 24, 2025

Related U.S. Application Data
(63) Continuation of application No. PCT/US2023/028688, filed on Jul. 26, 2023.
(60) Provisional application No. 63/392,330, filed on Jul. 26, 2022.

(51) Int. Cl. C02F 1/52; C02F 1/78; C02F 101/20; C02F 103/10

(52) U.S. Cl. CPC C02F 1/5236; C02F 1/78; C02F 2101/20; C02F 2101/203; C02F 2101/206; C02F 2103/10; C02F 2209/06; C02F 2301/08

(57) ABSTRACT

The disclosed method utilizes chemical-free ozone oxidative precipitation for the recovery of dissolved (such as Co, Mn, Ni, Cu, Ag, Cd, Zr, Ce, Os, Ir, Pd, Pt, Rh, Ru, Cr, Fe, Bi, Ga, Sn, and/or Tl) metal ions from aqueous solutions. The aqueous solutions could be mine or industrial influenced water or leachate obtained by processing primary or secondary sources of the elements. The process selectively separates these elements from aqueous streams and may be utilized in purification processes. The target elements are recovered without pH adjustment by chemicals, or using expensive oxidizers, thereby minimizing the process cost, chemical consumption, and environmental footprints. In acidic and circumneutral solutions, these elements can be recovered as solid precipitates. In alkaline solutions, these elements will be recovered again as solid precipitates.

### RELATED APPLICATIONS

This patent application claims priority to, and the benefit of, U.S. provisional application, U.S. 63/392,330, filed on Jul. 26, 2022, entitled “OZONE OXIDATIVE PRECIPITATION OF ELEMENTS FROM AQUEOUS STREAMS”, which is hereby incorporated by reference herein in its entirety.

### STATEMENT OF GOVERNMENT SUPPORT

This invention was made with government support under Contract No. DE-FE0022594 awarded by the Department of Energy. The Government has certain rights in the invention.

### BACKGROUND

Cobalt (Co) and manganese (Mn) are among the critical elements listed by the U.S. Department of Interior, and the U.S. is heavily reliant on foreign sources for these elements [1-4]. Co is a silvery-gray metal with a wide range of applications due to its unique properties, including ferromagnetism, hardness, wear-resistance when alloyed with other metals, low thermal and electrical conductivity, high melting point, and multiple valences. In the U.S., the majority of Co (i.e., 42%) was used in superalloys, mainly in aircraft gas turbine engines, followed by chemical applications (33%), metallic applications (16%), and manufacturing of cemented carbides for cutting and wear-resistant applications (9%) in 2021 [3]. Mn, a ferrous metal, is mainly used in steel production because of its desulfurization ability and powerful deoxidation capacity [5]. It is also widely used for non-metallurgical purposes such as the production of animal feed, brick colorant, dry cell batteries, and fertilizers [3,4]. The demand for Co and Mn is expected to grow because of their applications as battery materials in electric vehicles. The rise of electric vehicle manufacturing, driving a 60-70% increase in global Co demand for battery use, is likely to further boost the need for Co products [1,6].

Since the primary resources of Co and Mn are limited within the U.S., it is essential to explore and extract these elements from viable secondary resources such as waste streams associated with mining and processing of coal and various ore deposits. One of these waste streams is acid mine drainage (AMD), which originates from the oxidation of pyrite content in mining and processing waste streams [7-11].

Oxidation of pyrite in the waste streams of coal and sulfide minerals in the presence of oxygen and water releases ferric, sulfate, and hydrogen ions, resulting in the generation of an acidic effluent (i.e., AMD). The mechanism of AMD formation involves oxidation of pyrite, oxidation of ferrous iron, and further oxidation of pyrite by ferric iron.

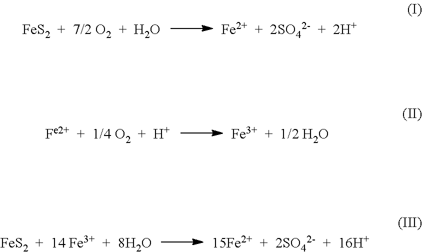

This acidic effluent promotes the dissolution of elements (i.e., major and trace elements, including critical elements) present in the host rocks within the waste streams due to the elevated hydroxide solubility of metals in strongly acidic conditions [8,15,11]. The acidity, high total dissolved solid content, and high electrical conductivity of AMD are of environmental concern. AMD is required to be treated to meet the environmental regulations before being discharged into the environment [16]. The treatment typically involves neutralizing AMD and precipitating metals by chemical addition. Recovery of critical elements while treating AMD enhances the sustainability of the treatment process.

The main methods for the recovery of Co and Mn from aqueous streams include precipitation (i.e., hydroxide, carbonate, ammonia, sulfide, and oxidative precipitation), solvent extraction, electrochemical recovery, and ion exchange [17,22]. Hydroxide precipitation is more efficient when combined with other methods to separate Mn from other metals in a solution [22]. Carbonate/ammonia precipitation is another practical method for Mn recovery from an aqueous solution. This method is more selective than hydroxide precipitation for Mn recovery at pH>8.5. Sulfide precipitation (using H₂S, Na₂S, and (NH₄)₂S) and ion exchange effectively recover Mn and other metals such as Co and Ni [22]. Mn recovery as insoluble manganese oxides (mostly MnO₂) from Zn, Co, and Ni aqueous solutions has been reported by oxidative precipitation [22]. Various oxidants, including SO₂/O₂, ozone (O₃), Caro's acid (H₂SO₅), peroxydisulfuric acid (H₂S₂O₈), hypochlorite (ClO⁻) and chlorite, sodium persulfate (Na₂S₂O₈), and potassium permanganate (KMnO₄), have been used for Mn and Co recovery from aqueous solutions [27-28,22]. Solvent extraction using Di(2-ethylhexyl)phosphoric acid has also been reported for selective separation of Mn from an aqueous solution containing Co, Ni, and Mg. In this method, the cost of base required for neutralization is considerable [22]. Resin-based ion exchange is another environmentally friendly and easy-to-control method to separate Mn from Co, Cu, Ni, Pb, and Fe. However, the capacity of a resin is restricted to the adsorption of certain metals, and therefore, the method is more appropriate for the purification process [22].

Electrochemical methods such as chemical-less approaches are also expected to selectively recover dissolved metals from aqueous solutions using oxidizing and neutralizing agents. Process efficiency and selectivity, desired product grade, and reagent cost are among the determining factors in selecting the appropriate methods for the recovery of metals (such as Co and Mn) from aqueous solutions [17,22].

There have been a few studies on selective recovery and purification of Co, Mn, and Ni from AMD sources. Considering the flow of AMD streams, required treatment capacity, and chemical cost, the precipitation method offers a viable solution for the recovery of Co and Mn from AMD. Staged precipitation is an effective approach for the selective recovery of elements as it precipitates them in sequential stages and produces multiple precipitate products [11]. However, precipitation of Co and Mn from AMD throughout the neutralization process is challenging because these elements do not precipitate at the circumneutral pH. Their precipitation throughout conventional hydroxide AMD treatment process starts at pH of approximately 9. Their high recovery requires an even higher pH (˜10.5). A high recovery of Mn (i.e., 99%) from AMD at pH 7 has been reported by oxidative precipitation using KMnO₄. However, the high chemical cost is the economic drawback of this process. Therefore, the development of a process for selective recovery of Co and Mn throughout AMD treatment process without the need for elevated pH or the use of costly requires a new technical solution. The precipitation behavior of elements during AMD treatment depends mainly on the available ligands, solution chemistry, and elemental concentration [11].

### SUMMARY

The disclosed system and method utilize chemical-free ozone oxidative precipitation for the recovery of dissolved metal ions (such as Co, Mn, Ni, Cu, Ag, Cd, Zr, Ce, Os, Ir, Pd, Pt, Rh, Ru, Cr, Fe, Bi, Ga, Sn, and/or Tl) from aqueous solutions. The aqueous solutions could be mine or industrial influenced water or leachate obtained by processing primary or secondary sources of the elements. The process could also selectively separate these elements from aqueous streams and can be utilized in purification processes. The advantages include a chemical-free process for the recovery or separation of the elements from aqueous streams and could be conducted at a wide range of original solution pH from acidic to basic. Therefore, without pH adjustment by chemicals, or using expensive oxidizers, these elements could be recovered, thereby minimizing the process cost, chemical consumption, and environmental footprints. In acidic and circumneutral solutions, these elements can be recovered as solid precipitates. In alkaline solutions, these elements will be recovered again as solid precipitates and also the pH solution will be reduced by ozone injection so that the final pH meets the discharge requirements.

In some aspects, the techniques described herein relate to a method of removing/recovering dissolved metals from an aqueous solution, the method including: a) mixing ozone into the aqueous solution thereby forming metal precipitates; and b) removing metal precipitates.

In some aspects, the techniques described herein relate to a method, the method further including: c) measuring a concentration of dissolved metals, Eh, and pH of the aqueous solution; and d) repeating steps a) to c) until the measured concentration of dissolved metals does not substantially change.

In some aspects, the techniques described herein relate to a method, wherein the aqueous solution includes one or more dissolved metals Co, Mn, Ni, Cu, Ag, Cd, Zr, Ce, Os, Ir, Pd, Pt, Rh, Ru, Cr, Fe, Bi, Ga, Sn, and/or Tl.

In some aspects, the techniques described herein relate to a method, the method including removing Fe, Al, Ca, Mg, Na, P, and/or rare earth elements before mixing ozone into the aqueous solution.

In some aspects, the techniques described herein relate to a method, the method including removing Fe, Al, Ca, Mg, Na, P, and/or rare earth elements after step d).

In some aspects, the techniques described herein relate to a method, wherein ozone is mixed into the aqueous solution at a predetermined flow rate.

In some aspects, the techniques described herein relate to a method, wherein the aqueous solution is at a temperature of about 0-80° C. during steps a) to d).

In some aspects, the techniques described herein relate to a method, wherein a flow rate of ozone is varied when steps a) to c) are repeated.

In some aspects, the techniques described herein relate to a method, wherein a temperature of the aqueous solution is varied when steps a) to c) are repeated.

In some aspects, the techniques described herein relate to a method, wherein steps a) to c) are repeated until the measured pH is about 8.0.

In some aspects, the techniques described herein relate to a method, wherein the aqueous solution has a pH of about 0-12.

In some aspects, the techniques described herein relate to a method, wherein the aqueous solution includes acid mine drainage, mine-influenced water, industrial wastewater, brines, geothermal brine, oil and gas produced water and wastewater, sludge leachate, electronic waste recycling leachate, battery recycling leachate, solar panel recycling leachate, leachate/pregnant leaching solution obtained from processing ores and any other primary and secondary sources of the metals, or other aqueous waste including Co, Mn, Ni, Cu, Ag, Cd, Zr, Ce, Os, Ir, Pd, Pt, Rh, Ru, Cr, Fe, Bi, Ga, Sn, and/or Tl.

In some aspects, the techniques described herein relate to a method, wherein the dissolved metals form precipitates, wherein the precipitates are Co, Mn, Ni, Cu, Ag, Cd, Zr, Ce, Os, Ir, Pd, Pt, Rh, Ru, Cr, Fe, Bi, Ga, Sn, and/or Tl precipitates.

In some aspects, the techniques described herein relate to a method, wherein about 50-99% of the dissolved metals from the aqueous solution are recovered as precipitates.

In some aspects, the techniques described herein relate to a method, wherein the precipitates of the dissolved metals are purified for secondary uses.

In some aspects, the techniques described herein relate to a method of recovery of dissolved metals from an acid mine drainage stream, the method including: a) removing Fe; b) removing Al; c) removing REEs; d) mixing ozone into the acid mine drainage stream at a rate thereby forming precipitates of dissolved metals; e) separating the precipitates of the dissolved metals; f) measuring a concentration of dissolved metals and pH of the acid mine drainage stream; and g) repeating steps d)-f) until the measured concentration of the dissolved metals does not change.

In some aspects, the techniques described herein relate to a method, wherein Fe is removed by aeration or chemical precipitation.

In some aspects, the techniques described herein relate to a method, wherein Al is removed by chemical precipitation at low pH.

In some aspects, the techniques described herein relate to a method, wherein rare earth elements are removed by chemical precipitation at acidic or neutral pH.

In some aspects, the techniques described herein relate to a method of purification or selectively recovering dissolved metals from an aqueous solution, the method including: a) adjusting a pH of the aqueous solution to a predetermined pH; b) flowing ozone into the aqueous solution to achieve a predetermined oxidation-reduction potential and stirring the aqueous solution for a predetermined period of time, thereby forming a first solid metal fraction; c) separating the first solid metal fraction; and d) repeating steps a)-c) for a second or more solid metal fraction.

In some aspects, the techniques described herein relate to a method, wherein one of the first, second or more solid metal fraction includes the dissolved metals, wherein the dissolved metals are one or more of Co, Mn, Ni, Cu, Ag, Cd, Zr, Ce, Os, Ir, Pd, Pt, Rh, Ru, Cr, Fe, Bi, Ga, Sn, and/or Tl.

In some aspects, the techniques described herein relate to a method, wherein the predetermined pH is in a range of about 0 to about 8.

In some aspects, the techniques described herein relate to a method, wherein the aqueous solution is a brine, waste waters of mine, oil and gas industry, or a leachate obtained by processing ores, processing secondary sources, processing waste, processing sludge, processing precipitates, or recycling electronic waste, battery, and solar panel.

In some aspects, the techniques described herein relate to a method, wherein about 50-99% of metals from the first, second, or more solid metal fraction of the aqueous solution are recovered.

### BRIEF DESCRIPTION OF DRAWINGS

The skilled person in the art will understand that the drawings described below are for illustration purposes only.

FIG. 1 shows a schematic representation of the staged precipitation.

FIGS. 2A-2E show Eh-pH diagrams for different ligands showing the predominant species in Mn- and Co—H₂O system at 25° C.

FIGS. 3A-3D show cumulative recovery of Mn (FIG. 3A) and Co (FIG. 3B) and grade of Mn (FIG. 3C) and Co (FIG. 3D) in staged precipitation of AMD using various chemicals.

FIGS. 4A-4C show cumulative recovery of Mn (FIG. 4A) and Co (FIG. 4B) achieved using various oxidizers in the AMD staged precipitation, where stages I and II represent the two-stage carbonate precipitation process for the removal of Al and REEs at pH values of 5 and 7, respectively, and Stage III denotes the oxidative precipitation for recovery of Co and Mn at pH 7, with corresponding grades (FIG. 4C) of the various elements in the precipitates of this stage.

FIG. 5 shows progression of oxidative precipitation by ozone injection in 20 L of AMD at Stage III (pH 7) as a function of time.

FIG. 6 shows result of the staged precipitation process developed for AMD treatment for Fe removal and selective recovery of Al, REEs, Co and Mn.

FIGS. 7A-7D show XRD patterns (FIG. 7A); FT-IR peaks (FIG. 7B); EDS peaks (FIG. 7C); SEM micrographs (FIG. 7D) of precipitated solids from oxidative ozone precipitation.

FIG. 8 shows a response surface plot for the Co recovery as a function of process parameters.

FIG. 9 shows a response surface plot for the Mn recovery as a function of significant process parameters.

FIGS. 10A-10D show Co precipitation rate versus temperature.

FIGS. 11A-11E show Mn precipitation rate versus temperature.

FIGS. 12A-12B show the activation energy for Co (FIG. 12A) and Mn (FIG. 12B) solution at two different times (60 seconds and 30 minutes).

FIGS. 13A-13D show Co—Mn precipitation rate versus stirring rate.

FIGS. 14A-14F show Co—Mn precipitation rate versus initial ion concentration.

FIGS. 15A-15D show Co—Mn precipitation rate versus flow rate.

FIGS. 16A-16R show Eh-pH diagrams for different elements showing the predominant species in H₂O system at 25° C.

FIG. 17 shows critical elements selective recovery by ORP control in Co—Mn stock solution.

FIG. 18 shows critical elements selective recovery by ORP control in the AMD/Sludge leachate solution.

FIG. 19 shows critical elements selective recovery from E-waste leachate using ozone oxidative precipitation by controlling ORP.

### DETAILED SPECIFICATION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The expressions “ambient temperature” and “room temperature” as used herein are understood in the art and refer generally to a temperature from about 20° C. to about 35° C.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between”, “adjacent” versus “directly adjacent”, “on” versus “directly on”).

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

It will be understood that, although the terms “first”, “second”, etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially”, in, for example, the context “substantially identical reference composition,” or “substantially identical reference article,” or “substantially identical reference electrochemical cell” refers to a reference composition, article, or an electrochemical cell comprising substantially identical components and wherein an inventive component is substituted with a common in the art component.

The systems and methods of the appended claims are not limited in scope by the specific systems and methods described herein, which are intended as illustrations of a few aspects of the claims. Any systems and methods that are functionally equivalent are intended to fall within the scope of the claims. Various modifications of the systems and methods, in addition to those shown and described herein, are intended to fall within the scope of the appended claims. Further, while only certain representative systems and method steps disclosed herein are specifically described, other combinations of the systems and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention nor the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

While aspects can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

In view of the described processes and compositions, hereinbelow are described certain more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

The present invention may be understood more readily by reference to the following detailed description of various aspects of the invention and the examples included therein and to the Figures and their previous and following description.

In an exemplary aspect, a method of removing dissolved metals from an aqueous solution is described. The method may comprise a) mixing ozone into the aqueous solution thereby forming dissolved metal precipitates then b) removing the dissolved metal precipitates from the aqueous solution. The method may further comprise c) measuring the concentration of dissolved metals, the oxidation-reduction potential (Eh), and pH of the aqueous solution. The method may comprise d) repeating steps a) to c) until the measured concentration of dissolved metals does not substantially change.

In some aspects, the aqueous solution may comprise one or more dissolved metals Co, Mn, Ni, Cu, Ag, Cd, Zr, Ce, Os, Ir, Pd, Pt, Rh, Ru, Cr, Fe, Bi, Ga, Sn, and/or Tl. In particular, the aqueous solution may comprise dissolved Co and Mn.

In some aspects, the method may comprise removing Fe, Al, Ca, Mg, Na, P, and/or rare earth elements before mixing ozone into the aqueous solution. In other aspects, the method may comprise removing Fe, Al, Ca, Mg, Na, P, and/or rare earth elements (REEs) after step d).

In some aspects, the method may include mixing ozone into the aqueous solution at a predetermined flow rate. The flow rate may be determined by the engineering parameters of the treatment system. For example, a small-scale (about 1-100 L aqueous solution) treatment system may use an ozone flow rate of about 500-1100 mL/min. In particular, an ozone flow rate of about 600 mL/min, about 700 mL/min, about 800 mL/min, about 900 mL/min, or about 1000 mL/min may be supplied to the treatment system containing about 10 L, about 20 L, about 30 L, about 40 L, about 50 L, about 60 L, about 70 L, about 80 L, or about 90 L of aqueous solution. A person of ordinary skill in the art may use techniques known in the art to determine an optimal flow rate. In some aspects, the flow rate of ozone may be varied throughout the method, in particular, after removal of a dissolved metal precipitate.

In some aspects, the aqueous solution may be at a temperature of about 0° C. to about 80° C. Throughout the various steps of the method, the temperature may be varied to optimize precipitation of a desired dissolved metal; examples of which are disclosed in the Examples section. In particular, the aqueous solution may be at a temperature of about 10° C., about 20° C., about 30° C., about 40° C., about 50° C., about 60° C., or about 70° C. In some aspects, the temperature of the aqueous solution may be varied throughout the method, in particular, after removal of a dissolved metal precipitate.

In some aspects, the aqueous solution for treatment may have a pH of about 0 to about 12. In particular, the pH of the aqueous system may be about 1, about 2, about 3, about 4, about 5, about 6, or about 7 before treatment then the method steps a) to c) may be repeated until the measured pH is about 8. In another example, the pH of the aqueous system may be about 11, about 10, or about 9, before treatment, then the method steps a) to c) may be repeated.

In various aspects, the aqueous solution may comprise acid mine drainage, mine-influenced water, industrial wastewater, brines, geothermal brine, oil and gas produced water and wastewater, sludge leachate, electronic waste recycling leachate, battery recycling leachate, solar panel recycling leachate, leachate/pregnant leaching solution obtained from processing the ores and any other primary and secondary sources of the metals, or other aqueous waste comprising Co, Mn, Ni, Cu, Ag, Cd, Zr, Ce, Os, Ir, Pd, Pt, Rh, Ru, Cr, Fe, Bi, Ga, Sn, and/or Tl. In some aspects, the aqueous solution may be an aqueous stream.

In some aspects, the dissolved metals may form precipitates, wherein the precipitates may be Co, Mn, Ni, Cu, Ag, Cd, Zr, Ce, Os, Ir, Pd, Pt, Rh, Ru, Cr, Fe, Bi, Ga, Sn, and/or Tl precipitates. Using the above-described method, about 50-99% of the dissolved metals are recovered as precipitates from the aqueous solution. In particular, about 55%, about 60%, about 65%, about 70%, about 75%, about 80%, about 85%, about 90%, and/or about 95% of the dissolved metals are recovered as precipitates from the aqueous solution. After recovery, the dissolved metal precipitates may be purified for secondary uses.

In another exemplary aspect, a method of recovery of elements from an acid mine drainage stream is described. The method may comprise a′) removing Fe, b′) removing Al, c′) removing REEs, d′) mixing ozone into the acid mine drainage stream at a rate thereby forming precipitates of dissolved metals, e′) separating the precipitates of the dissolved metals, f′) measuring a concentration of dissolved metals and pH of the acid mine drainage sample, and g′) repeating steps d′)-f′) until the measured concentration of the dissolved metals does not change.

In some aspects of the method to recover elements from acid mine drainage streams, Fe may be removed by aeration or chemical precipitation. In other aspects, Al may be removed by chemical precipitation at low pH. In yet other aspects, REEs may be removed by chemical precipitation at acidic or neutral pH.

In another exemplary aspect, a method of purification or selectively removing metals from an aqueous solution is described. The method may comprise a″) adjusting a pH of the aqueous solution to a predetermined pH, b″) flowing ozone into the aqueous solution to achieve a predetermined oxidation-reduction potential and stirring the aqueous solution for a predetermined period of time, thereby forming a first solid metal fraction, c″) separating the first solid metal fraction, and d″) repeating steps a″)-c″) for a second or more solid metal fraction.

In some aspects, one of the first, second or more solid metal fraction may comprise the dissolved metals, wherein the dissolved metals in aqueous solutions are one or more of Co, Mn, Ni, Cu, Ag, Cd, Zr, Ce, Os, Ir, Pd, Pt, Rh, Ru, Cr, Fe, Bi, Ga, and/or Tl. In other aspects, the predetermined pH is in the range of about 0 to about 8. In particular, the predetermined pH may be about 1, about 2, about 3, about 4, about 5, about 6, or about 7.

In other aspects, the aqueous solution may be a brine, waste waters of mine, oil and gas industry, or a leachate obtained by processing ores, processing secondary sources, processing waste, processing sludge, processing precipitates, or recycling electronic waste, battery, and solar panel.

Using the above-described methods, about 50-99% of the dissolved metals are recovered as precipitates from the aqueous solution. In particular, about 55%, about 60%, about 65%, about 70%, about 75%, about 80%, about 85%, about 90%, and/or about 95% of the dissolved metals are recovered as precipitates from the aqueous solution.

### EXAMPLES

### Example 1. Chemical-Free Process Utilizing Ozone Oxidative Precipitation for the Recovery of Cobalt and Manganese from Acid Mine Drainage

Samples and materials. Representative samples from AMD (800 L) and sludge (800 L of slurry, which was decanted, filtered, and dried) were collected from an AMD treatment facility in Pennsylvania, operated by the Pennsylvania Department of Environmental Protection (PADEP). The AMD and sludge samples were collected at the feed points to the AMD treatment facility and the sludge pond during the sludge pumping, respectively. The AMD stream, which originated from the Lower Kittanning coal seam, had a measured pH of 3.5. The elemental composition of the AMD and the sludge samples are shown in Table 1.

TABLE 1
Elemental content of the AMD sample

| Element | Al | Fe | Mg | Mn | Cr | Co | Ni | Cu | Zn | TREE |
|---|---|---|---|---|---|---|---|---|---|---|
| AMD concentration (mg/L) | 45.6 | 4.7 | 399.8 | 41.8 | 0.9 | 0.9 | 1.6 | 0.1 | 3.1 | 0.5 |
| Sludge concentration (ug/g) | 45,089 | 4,563 | 106,856 | 31,481 | 2.1 | 1,180 | 2,371 | 79 | 3,177 | 553 |

The relatively high content of the critical elements in the AMD (e.g., 45.6 ppm Al, 0.5 ppm rare earth elements (REEs), 0.9 ppm Co, and 41.8 ppm Mn) shows that the AMD is a highly valuable secondary resource for multiple critical elements. The high concentration of these elements (e.g., 4.5% Al, 553 ppm REEs, 1180 ppm Co, and 3.1% Mn) in the associated sludge materials indicated that precipitation is a viable method for concentrating these elements from AMD. Therefore, it was contemplated that modification of precipitation method (i.e., staged precipitation) for selective recovery of these elements from AMD while treating addresses the environmental concerns. In the current example, NaOH, Na₂CO₃, Na₂HPO₄, NH₄OH, (NH₄)₂SO₄, Na₂SO₄, NH₄HCO₃, KMnO₄, Na₂S₂O₈, and O₃ were utilized to study the effects of various ligands and oxidants on the precipitation behavior of Co and Mn. All reagents were ACS grade. For the oxidative ozone precipitation, a 1000 mg/h ozone generator (T-king Enaly Model), with air as the input gas, was utilized for ozone supply. The volumetric flow rate of ozone injected into the system was controlled by a flowmeter.

Staged precipitation. A two-stage carbonate precipitation process for the selective recovery of Al and REEs from AMD was previously disclosed in [34]. In the previously described process, after aeration and removal of the Fe, 90% of Al was recovered in the first step, and 85% of REEs was recovered in the second step with a significantly high REEs concentration of 1.6%, using carbonate ligand (i.e., CO₂, or Na₂CO₃). The details of the two-stage precipitation process were described elsewhere [11, 34], and those conditions were utilized as the baseline for this presently described system and method. In the present example, a third precipitation stage was evaluated to recover Co and Mn. Each experiment was conducted using a 20 L AMD sample, which was first filtered to remove algae and coarse particles.

Ligand precipitation. The effect of various ligands on the precipitation of these elements was first studied using the staged precipitation process. Different chemicals including NaOH, Na₂CO₃, Na₂HPO₄, NH₄HCO₃, NH₄OH, (NH₄)₂SO₄, and Na₂S₂O₈ were used to investigate hydroxide, carbonate, ammonia, and sulfate precipitations. Upon aeration and removal of iron (at an approximate pH of 4), the pH of the solution was raised to the target pH values (i.e., 5, 7, 8, and 9) for each stage of the ligand precipitation. For the chemicals that did not raise the pH (i.e., Na₂HPO₄, (NH₄)₂SO₄, Na₂S₂O₈), NaOH was used as a pH modifier, after adding a constant dosage of the chemicals at each stage. This dosage was determined based on the required amount of the ligand to form metal complexes, if thermodynamically possible to form, while keeping the ionic strength of the associated solutions in the same order of magnitude as those of other chemicals. The concentrations of the chemicals and pH modifier at the precipitation stages are listed in Table 2. At each target pH value, the solution was stirred for 24 hours to provide an adequate aging time for nucleation and growth of the precipitates [35,36]. The precipitates were then collected by filtering the solution through a 0.45 μm hydrophilic polyvinylidene fluoride (PVDF) filter (Durapore® membrane—Millipore-Sigma) in a high-pressure (700 kPa) filtration setup. Finally, the collected precipitates of each stage were dried at a low temperature (70° C.) in a vacuum oven (−70 kPa) and stored sealed for characterization.

TABLE 2
Chemical consumption (mg/L) in each stage
of experiments using various ligands

| Chemical | pH 5 | pH 6 | pH 7 | pH 8 | pH 9 | Cumulative |
|---|---|---|---|---|---|---|
| NaOH | 118 | 12.6 | 4.8 | 7.2 | 23.0 | 165.6 |
| Na₂CO₃ | 169.6 | 18.6 | 4.2 | 7.4 | 34.5 | 234.3 |
| Na₂HPO₄ | 165.1 | 16.0 | 142.0 | 142.0 | 142.0 | 607.1 |
| NaOH | 64.0 | 0.0 | 0.0 | 64.0 | 128.0 | 256.0 |
| NH₄HCO₃ | 217.4 | 21.3 | 17.8 | 197.6 | 395.3 | 849.4 |
| NH₄OH | 168.6 | 20.7 | 5.2 | 13.0 | 129.7 | 337.2 |
| (NH₄)₂SO₄ | 116.2 | 116.2 | 116.2 | 116.2 | 116.2 | 581.0 |
| NaOH | 121.2 | 4.0 | 4.8 | 17.6 | 164.0 | 311.6 |
| Na₂SO₄ | 142.0 | 142.0 | 142.0 | 142.0 | 142.0 | 710.0 |
| NaOH | 126.0 | 10.0 | 1.8 | 3.6 | 104.0 | 245.4 |

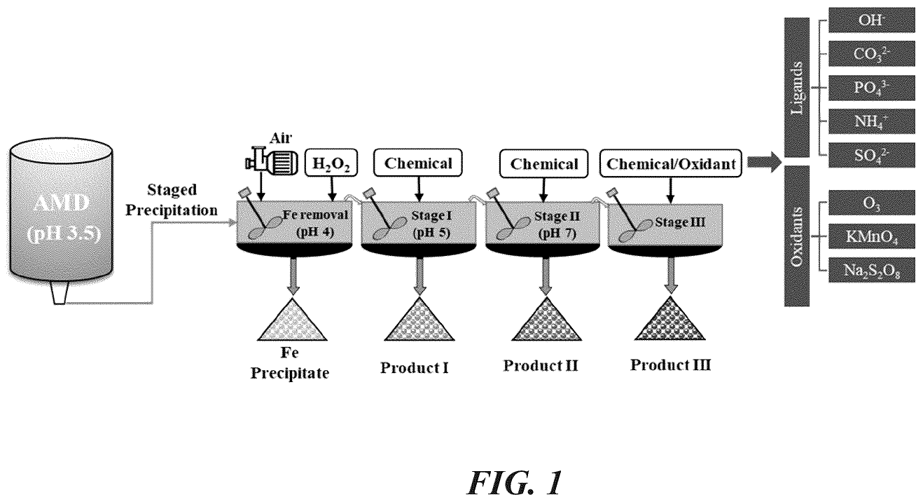

Oxidative precipitation. The oxidative precipitation of Co and Mn was studied using KMnO₄, Na₂S₂O₈, and O₃, as common oxidants used in Co and Mn separation processes [27,37-41]. The oxidative precipitation was performed on the neutralized AMD (i.e., pH 7) obtained from the two-staged carbonate precipitation process. The neutralized AMD was then oxidized by adding oxidants (i.e., KMnO₄, and Na₂S₂O₈) or injection of ozone (O₃) into the solution at the 500 ml/min rate, generating 1 g/h of ozone in the system. While stirring, oxidation was continued through incremental addition of the chemicals (i.e., 79 mg/l and 712 mg/l for KMnO₄, and Na₂S₂O₈, respectively) or ozone injection (for eight hours) until no more Co and Mn were precipitated. This was ensured when the concentration in the solution did not change over time, and the pH of the solution was maintained at approximately 7.0. The precipitates from each stage were collected by filtration as described in the following sections. The experimental setup is shown in FIG. 1.

Analytical procedure. The elemental concentration of AMD, sludge, precipitates, and solutions were measured using Agilent 7900 Inductively Coupled Plasma-Mass Spectrometry (ICP-MS). Before ICP analysis, sludge and precipitates were acid digested in aqua regia. The analyses were performed in duplicate, using ICP-MS standard solutions (ICP-MS-68B-A-100, HPS) with known elemental concentrations for quality control. Co—Mn precipitates were thoroughly characterized using X-Ray Diffraction (XRD), Fourier Transform Infrared (FTIR) Spectroscopy, and Scanning Electron Microscopy with Energy Dispersive X-ray Spectroscopy (SEM-EDS). The elemental recovery values were calculated based on the elemental concentrations with reference to Eq. 1, where Cᵢ is the concentration (mg/L) of the element of interest in the solution after filtration at each stage, and C is the concentration of the same element in the AMD feed.

$$Recovery ( \% ) = 100 \times ( 1 - \frac{{C}_{i}}{{C}_{f}} ) \qquad ( Eq . 1 )$$

Solution chemistry. Pourbaix diagrams of Co and Mn with the ligands (NH₄⁺, SO₄²⁻, PO₄³⁻, OH⁻, CO₃²⁻) at 25° C. were constructed. For the solution chemistry study, the concentration of Co and Mn were similar to that of the AMD sample, and the ligand concentrations were selected based on their consumption throughout the precipitation experiments (shown in Table 2).

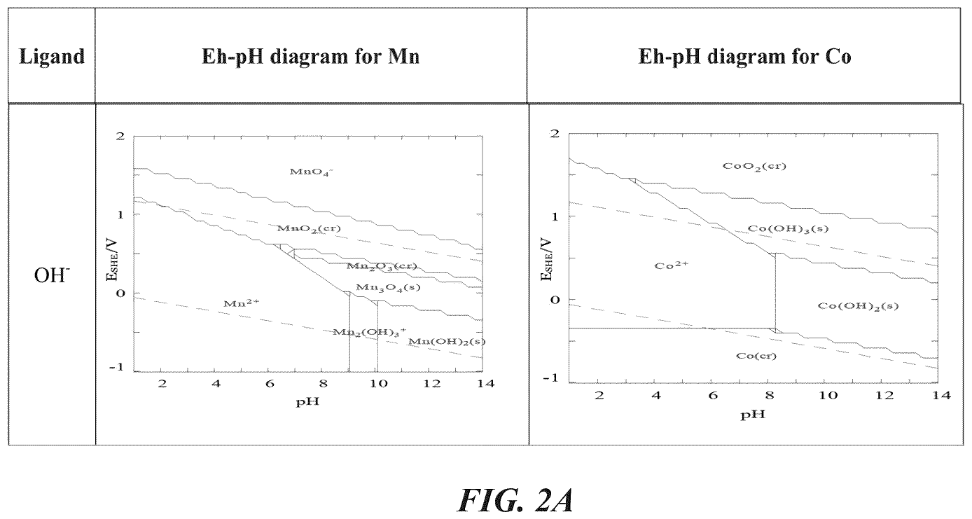

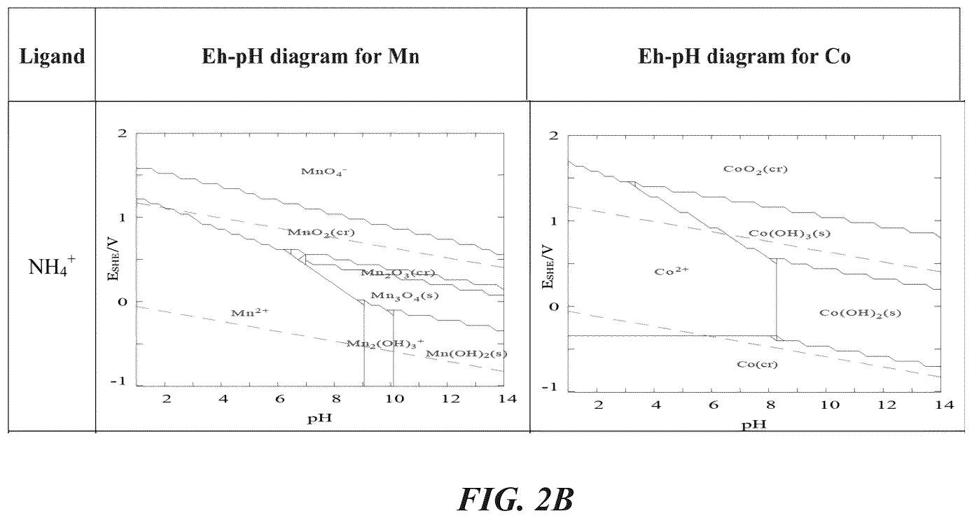

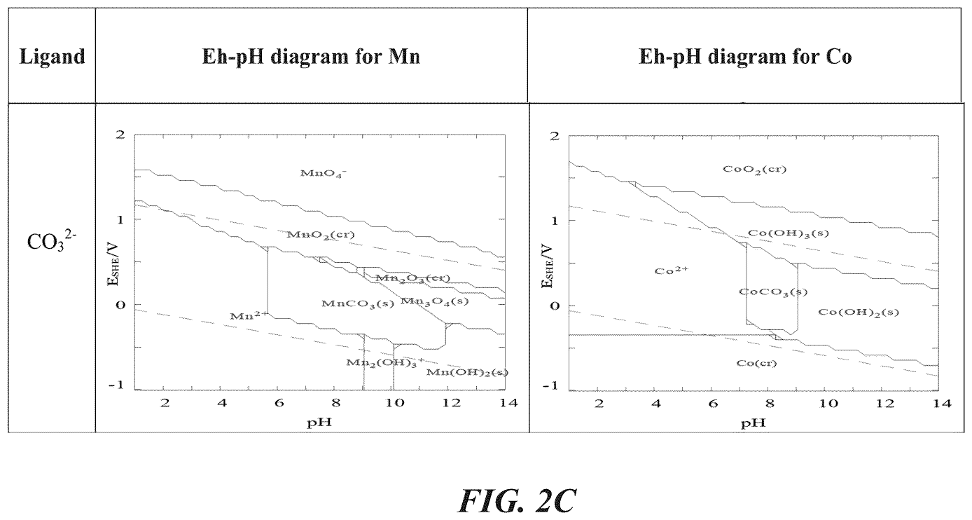

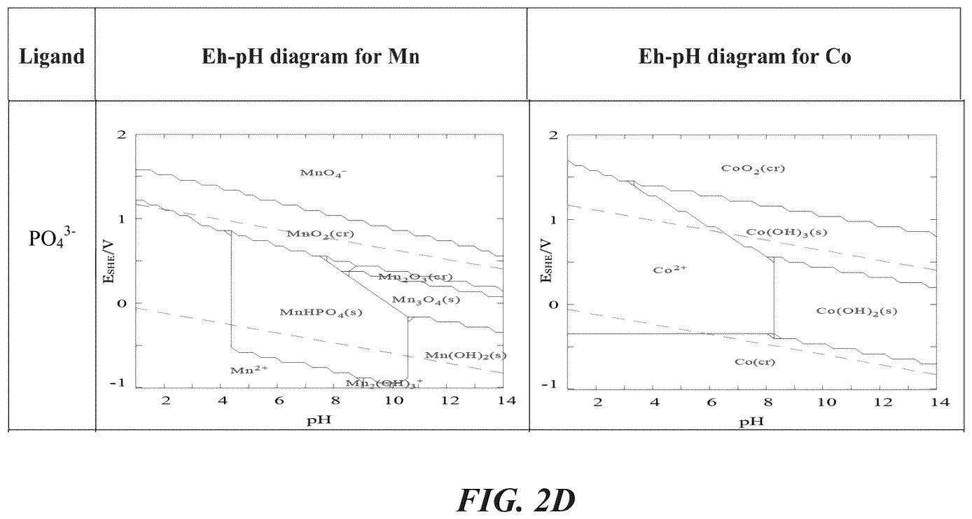

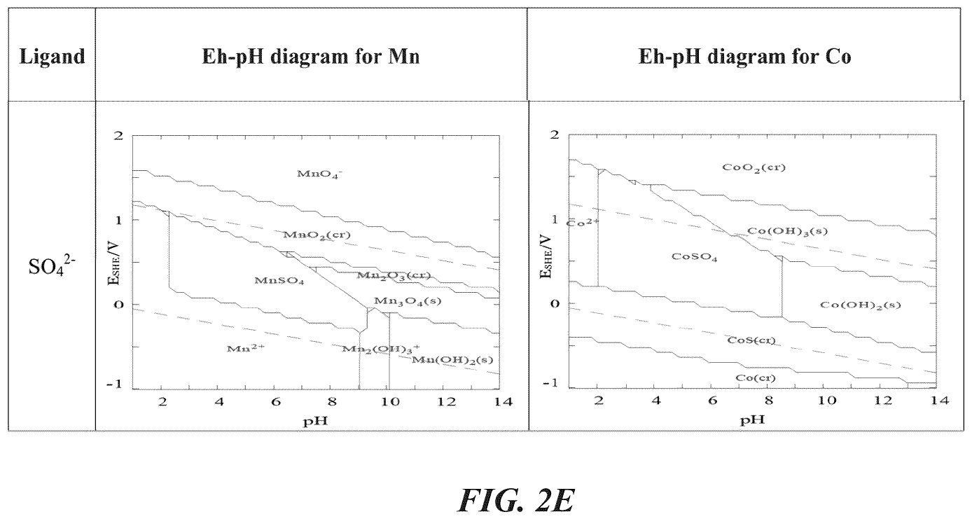

Eh-pH diagrams. The Pourbaix diagrams of Co and Mn systems with various ligands are presented in FIGS. 2A-2E. The total dissolved Co and Mn concentrations were fixed at constant values of 0.1 mM and 1 mM, respectively. Each system's ligands concentration was set according to those used in the precipitation experiments (i.e., Table 2).

Based on the Pourbaix diagrams of Mn, shown in FIGS. 2A-2E, in general, Mn presents as an ion in the solution at low pH and Eh conditions, and the variation from these conditions results in the precipitation of Mn. In a highly acidic environment, increasing Eh (by using an oxidant as an example) results in precipitation of Mn in the form of MnO₂. By increasing Eh at higher pH values, higher grade Mn formations such as Mn₂O₃ (in a narrow intermediate oxidation potential region between MnO₂ and Mn₃O₄) and Mn₃O₄ will also be developed, resulting in the precipitation of Mn. However, at relatively low Eh values, Mn precipitation requires relatively high pH values, depending on the type of ligand. This is consistent with the previous research studies, which found an increase in the efficiency of Mn precipitation as the solution pH rises, using various ligands [27,42].

In hydroxide precipitation (FIG. 2A) Mn was present as an ion in the solution at pH values below 9, above which formation of Mn(OH)₂ occurs. Similar results with Mn compound formations were observed in the presence of NH₄⁺ ligand (FIG. 2B). With carbonate ligand, the formation of MnCO₃ starts at lower pH values (e.g., approximately 6) (FIG. 2C). The results also indicated that Mn could even potentially precipitate at low pH and Eh values, in the form of MnHPO₄, in the presence of PO₄³⁻ (FIG. 2D). The presence of SO₄²⁻ in the acidic solution resulted in stabilizing Mn²⁺ in the form of ion-pairs (MnSO₄⁰), but precipitation of Mn occurs at higher (more than 8) pH values and in the forms of hydroxide or oxides, as shown in FIG. 2E.

Similar to Mn, Co, in general, exists as an ion in aqueous solutions at low pH and Eh conditions (FIGS. 2A-2E). Its precipitation occurs only at pH values of around 8.5, generally in the hydroxide form. Increasing the solution Eh can also precipitate this element at lower pH values (>6.5). The Pourbaix diagrams showed precipitation of Co as Co(OH)₂ and Co(OH)₃ by increasing pH to higher than 8.5 or Eh in the presence of OH⁻, NH₄⁺, PO₄³⁻ ligands (FIGS. 2A, 2B, and 2D). The Pourbaix diagram for the CO₃²⁻ ligand showed Co precipitation as COCO₃ at pH values of 7-9, followed by Co(OH)₂ at pH values higher than 9 (FIG. 2C). In the presence of SO₄²⁻ ligand, Co (similar to Mn) was also found to remain in the solution as CoSO₄⁻ at approximate pH of 2 (FIG. 2E). By increasing the pH, this element precipitates in the form of hydroxide or oxide. Co and Mn hydroxides, in the presence of air, are readily oxidized to the high valent oxyhydroxides (i.e., M(III)OOH, where M denotes the metal) [43]. The precipitation of CoOOH has also been reported in the literature [44,40,41].

Effect of various ligands on staged precipitation of Co—Mn. Using various chemicals, the effect of OH⁻, SO₄²⁻, NH⁴⁺, CO₃²⁻, and PO₄³⁻ ligands on Co and Mn precipitation from AMD was studied through the staged precipitation experiments. NaOH and Ca(OH)₂, providing OH⁻ ions in the solution, are the most common chemicals used in AMD active treatment processes. The general reaction for metal hydroxide precipitation can be expressed by Reaction IV, where M denotes the metal and n represents the metal valence. The equilibrium constant for this reaction can be expressed by Eq. 2, where Kₛ is the solubility product.

$$Mn ++ n OH = M ( OH ) n \qquad ( IV )$$

$${K}_{1} = \frac{1}{{[ {M}^{n +} ] [ OH ]}^{n}} = 1 / {K}_{S} \qquad ( Eq . 2 )$$

Based on the metal's hydroxide solubility diagrams, it is predicted that Fe³⁺, Al³⁺, Pb²⁺, and Cu²⁺, followed by Zn²⁺ could be easily separated from Mn²⁺ by hydroxide precipitation due to the differences in their solubilities. However, separating Co²⁺ and Ni²⁺ from Mn²⁺ by hydroxide precipitation is challenging [23]. Therefore, hydroxide precipitation is not an efficient approach for selective recovery of Mn from aqueous solutions, and this approach is only practical when combined with other separation techniques [22,23].

Na₂CO₃ is another chemical used in AMD treatment and was utilized in this study to provide CO₃²⁻ ligand in the solution. Carbonate precipitation is an efficient method for recovering Mn and Co, especially when combined with ammonia. However, separating Mg²⁺ and Ca²⁺ ions from Mn²⁺ ions in sulfate solutions (such as AMD) during chemical precipitation of MnCO₃ (i.e., Reaction V) is often challenging due to their similar chemical characteristics [25,26]. Depending on the temperature, pH, and Mg/Ca ratio, these two elements can co-precipitate with Mn, reducing the selectivity of the precipitation process and grade of Mn product [26].

$${Mn}^{2 +} + {CO}_{3}^{2 -} = Mn {CO}_{3} \qquad ( V )$$

The ligands and metal ions, such as SO₄²⁻, in a solution affect the precipitation pH of the elements. This is due to the association of metal ions with SO₄²⁻ anions, producing ion-pairs such as CoSO₄⁻, NiSO₄⁻, and FeSO₄⁻ (with corresponding log(K) in the range of 1-2.5, i.e., reactions VI-VIII). There is a significant difference in the equilibrium constant for the precipitation of Ni(OH)₂ from Ni²⁺, and NiSO₄⁻ (i.e., reactions IX and X), with the latter (particularly in the presence of SO₄²⁻) having a smaller solubility constant, thereby, a higher precipitation pH [43]. Similar reactions can occur when Co and Mn ions are in the solution.

$${Ni}^{2 +} + {SO}_{4}^{2 -} = NiS {O}_{4} log K = 2 \text{.29} \qquad ( VI )$$

$${Co}^{2 +} + {SO}_{4}^{2 -} = CoS {O}_{4} log K = 2.42 \qquad ( VII )$$

$${Fe}^{3 +} + {SO}_{4}^{2 -} = {FeSO}_{4}^{+} log K = 1.94 \qquad ( VIII )$$

$${{Ni}^{2 +} + {H}_{2} O = {Ni ( OH )}_{2} + 2 H}^{+} log K = - 1 2.8 \qquad ( IX )$$

$$NiS {O}_{4} + {H}_{2} O = N {i ( OH )}_{2} + 2 {H}^{+} + {SO}_{4}^{2 -} log K = - 15.1 \qquad ( X )$$

Ammonia is also used in AMD treatment [45]. It has also been widely employed as an efficient lixiviant in various hydrometallurgical processes because of its low toxicity, low cost, and ease of regeneration using evaporation. Ammonia-ammonium carbonate solutions have been used for the selective recovery of cobalt from a mixed Co—Mn aqueous solution. Cobalt ammine complexes are more stable than manganese ones and can be rapidly oxidized to cobalt (Ill) hexammine salts. The complex of hexammine from cobalt (II) ions is generated when excess ammonia is introduced to a solution containing Co²⁺ ions [46-48, 24]. The effect of ammonia on the precipitation of Co and Mn, using NH₄OH, and NH₄HCO₃ was investigated in this example. Furthermore, (NH₄)₂SO₄, and Na₂SO₄, NaHPO₄ were also utilized to study the effect of NH₄⁺/NH₃, and SO₄²⁻, and PO₄³⁻ anions on the precipitation of Co and Mn.

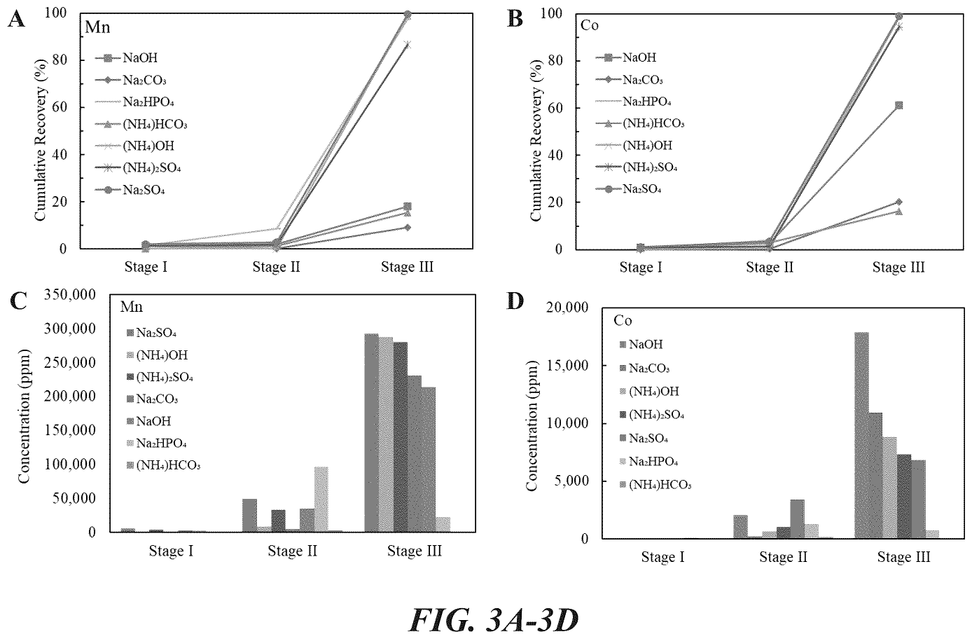

The precipitation behavior of cations in solution is greatly influenced by their interactions with other ions in the aqueous environment and the properties of the elements [33,49,11]. The precipitation experiments with various ligands show the cumulative recovery and grade of Co and Mn at various stages (i.e., Stage I at pH 5, Stage II at pH 7, and Stage III at pH 9) of the precipitation experiments with various ligands are shown in FIGS. 3A-3D. The results showed that at low Eh condition of the AMD (i.e., 0.3 V), regardless of the ligands present in the solution, precipitation of Co and Mn starts at the elevated pH values (≥9), except for PO₄³⁻ ligand for which the elements began to precipitate considerably at pH 8. NaOH could recover less than 20% of Mn and only 61% of Co at pH 9. These results are consistent with the corresponding Pourbaix diagrams (per FIGS. 2A-2E), indicating that a pH of 10 was required for the hydroxide precipitation of Mn. Carbonate ligand provided by Na₂CO₃, or NH₄HCO₃ was ineffective as only less than 20% Co and Mn were recovered. A previous study by Lin et al. [25] showed that precipitation of Mn²⁺, Mg²⁺, and Ca²⁺ in carbonate precipitation is different from hydroxide precipitation. The precipitation potential of these elements at a given pH follows the following sequence: MnCO₃>CaCO₃>MgCO₃>Mn(OH)₂>Mg(OH)₂>Ca(OH)₂. Thus, based on thermodynamics, carbonate precipitation is more feasible to separate Mn from Mg and Ca than hydroxide precipitation and offers more selectivity for Mn over Ca or Mg [25]. However, in the present example, recovery values of Co and Mn at lower precipitation pH did not occur and were also low at pH 9. This is likely due to the low concentration of Mn—Co in the solution, as the rate of Co—Mn precipitation is significantly affected by the metal ion's initial concentration.

Other ligands, including PO₄³⁻, NH₄⁺, and SO₄²⁻, provided by Na₂HPO₄, NH₄OH, (NH₄)₂SO₄, and Na₂SO₄, achieved high recovery of Co and Mn (i.e., more than 87%) at pH 9. High recovery values using PO₄³⁻ ligand is consistent with the corresponding Pourbaix diagrams (FIG. 2D). This is attributed to the lower Gibbs free energy of the corresponding phosphate formations [50].

Cationic complexes of Mn and ammonia in the type Mn(NH₃)ⁿ⁺ are produced when ammonia is introduced into Mn solutions. The precipitation of Co and Mn in the presence of ammonium and sulfate ligands revealed the oversaturation of the corresponding complexes of these elements. NH₄⁺ and SO₄²⁻ ligands precipitate Co and Mn as metal hydroxides (FIGS. 2B and 2E). Ammonium salts at moderate concentrations satisfy stoichiometric requirements of ammonia to precipitate Mn hydroxide in the absence of oxidation. In ammoniacal media, the addition of ammonium sulfate lowers the solution pH and increases the stability of Mn ammine. Mn ammine will hydrolyze into Mn hydroxide in the absence of ammonium sulfate [51].

The precipitates' grades showed no significant differences among the various ligands in terms of selectivity toward the precipitation of Co and Mn. The corresponding grades were in the same order of magnitude (˜20-30% Mn, and <1.8% Co). PO₄³⁻ ligand precipitated a high amount of Ca (i.e., approximately 60% recovery) at pH 9, which lowered the grade of Co and Mn in the precipitates, despite high recoveries.

Comparing the performance of the various chemicals for the precipitation of Co and Mn, NH₄OH resulted in the highest recovery (>98%) and grade (0.9% Co and 29% Mn) of these elements at pH 9, which was achieved without the addition of other pH modifiers. Among the efficient chemicals, NH₄OH also offered the least chemical consumption, low cost, and environmental concern. This chemical has also been widely used in AMD treatment. Therefore, it can be combined with the previously two-stage carbonate (provided by CO₂ or Na₂CO₃) precipitation process for the selective recovery of Al and REEs from AMD. In the combined process, AMD was first aerated for removing Fe at pH 4, followed by carbonate precipitation of Al and REEs at pH 5 and 7, respectively. Finally, NH₄OH was added to precipitate Co and Mn at pH 9. In some cases, the discharge was diluted with AMD to reduce its pH to circumneutral. In such cases, it is contemplated that oxidative precipitation of Co and Mn of the treated water (i.e., pH 7) obtained from the two-staged precipitation process can be used to reduce the chemical consumption and address the high pH discharge issue.

Effect of various oxidizers on staged precipitation of Co—Mn. Oxidative precipitation of Co and Mn was investigated as an alternative approach to avoid the higher pH requirement for the precipitation of Co and Mn from AMD. Oxidative precipitation has been documented to be very effective in hydrometallurgical processing [37,27,22]. Mn impurity removal from Zn, Co, and Ni processing circuits has been achieved by oxidative precipitation of Mn as insoluble manganese oxides, mainly MnO₂. The standard reduction potential of MnO₂, as a strong oxidizing agent, is 1.224 V. Therefore, oxidation of Mn(II) to higher valence oxides, first Mn(III) and then MnO₂, requires a strong oxidant such as ozone, peroxydisulfuric acid, SO₂ mixture with O₂, or Caro's acid [22].

This example shows the oxidative precipitation of Co and Mn from AMD using Na₂S₂O₈, KMnO₄, and ozone as oxidizers. The oxidizers were added/purged to the treated/neutralized AMD after the two-staged precipitation process (i.e., at pH 7). The oxidative precipitation may be a third treatment stage after two-stage precipitation processing using the previously disclosed methods. Na₂S₂O₈ has been found to be effective for oxidation of Mn in acidic aqueous systems (i.e., Reaction XI). However, the precipitation of Co using this oxidant or potassium persulfate (K₂S₂O₈) was limited and only through the adsorption to the manganese oxide complexes and not due to the cobalt oxide/hydroxide precipitation. In the reported experiment, four times the stoichiometric amount of Na₂S₂O₈ was used [28,53].

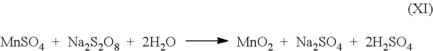

Mn has also been rapidly and effectively oxidized using KMnO₄ in highly contaminated AMDs (i.e., Reaction XII). In a study conducted by Freitas et al. [27] more than 85% of Mn was precipitated using this oxidant from AMD samples at both acidic and neutral pH conditions. The Mn precipitates were found in the forms of birnessite, pyrolusite, nsutite (MnO₂), hausmannite (Mn₃O₄), bixbyite (Mn₂O₃), and manganite (MnOOH). Depending on the pH, adsorption and coprecipitation could also contribute to removing Mn and other pollutants, including Ca, Co, and Zn, from aqueous solutions [27,54]. These mechanisms have been supported by less KMnO₄ consumption than the required amount based on the stoichiometry for removing Mn [27,54]. However, these mechanisms are not highly selective toward Mn ions, and therefore, the number of accessible sites for Mn adsorption would be less in the presence of other elements [27].

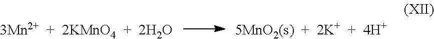

Traditional oxidation precipitation techniques frequently introduce second contaminants into the solution, which might impair the downstream electrowinning purification process. Among various oxidizers such as KMnO₄, NaClO, and Cl₂, ozone is regarded as a clean oxidant [41]. Ozone is an oxygen allotrope that is far less stable and significantly stronger than the diatomic allotrope (O₂) and is one of the most powerful oxidizing agents, with a standard redox potential of 1.24 V in alkaline solutions. It has also been widely used in various applications such as chemical processing, environmental protection, and food preservation [37-41].

Using a strong oxidant like ozone, Mn²⁺ and Co²⁺ could be oxidized to an unstable state, including Mn³⁺, Mn⁴⁺, and Co³⁺, which react with hydroxyl radicals and are removed from the solution as MnO₂, Mn₂O₃, and CoOOH, as described in the reactions XIII-XV. The Gibbs free energy (ΔG_{θ}) values of these oxidative precipitation reactions are negative; therefore, the reactions are thermodynamically feasible [41].

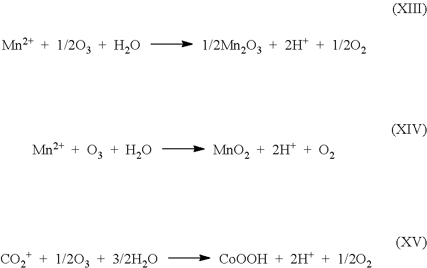

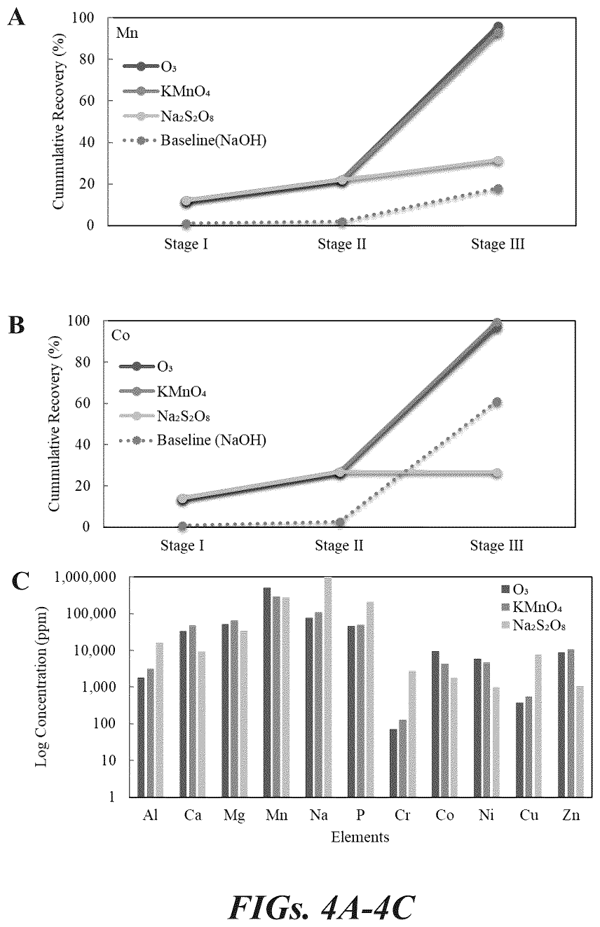

In our study, oxidative precipitation using ozone and KMnO₄ resulted in more than 90% recovery for both Co and Mn (FIG. 4A-4B), consistent with the aforementioned literature. However, Na₂S₂O₈ precipitation achieved low recovery values for Co and Mn, i.e., 15% and 31%, respectively. The low recovery of Co was expected due to the removal of this element only through the adsorption to the manganese oxide complexes. The low recovery of Mn using this oxidant could be attributed to the low concentration of this element in the initial AMD feed.

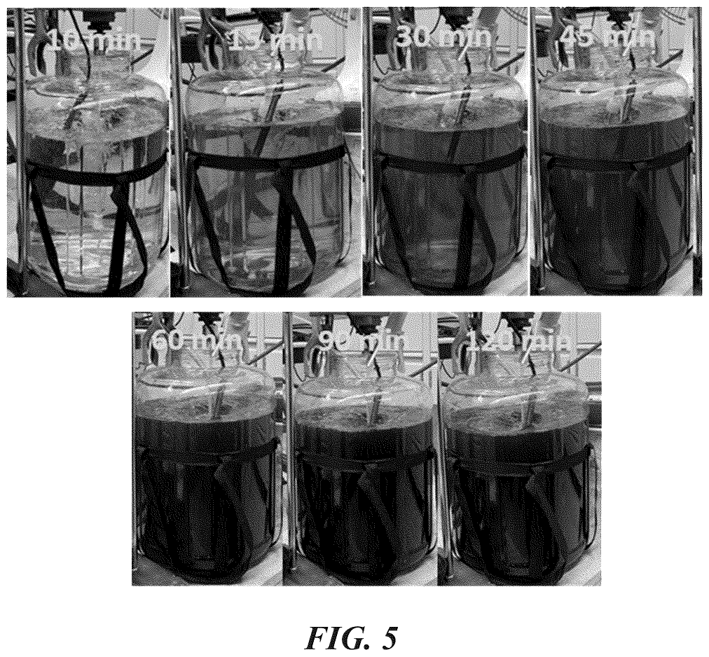

The grades of elements including Co and Mn and other major and critical elements in the precipitates obtained from the oxidative precipitations are shown in FIGS. 4A-4C. A high grade of Mn (28%-54.6%) was obtained using all three oxidizers. The highest grade of Mn (i.e., 54.6%) and Co were obtained by using ozone (i.e., 0.9% Co with ozone vs. 0.4% and 0.2% Co obtained from KMnO₄, and Na₂S₂O₈, respectively). The major impurities were Ca and Mg, which can be separated through downstream purification processes. For example, Lin et al. [25] used ammonium bicarbonate to selectively separate Mn from sulfate solutions containing Mg and Ca. The main advantages of using ammonium bicarbonate are low cost, easy-to-control reaction, and the lack of contaminants other than ammonium ions [25]. The reported other critical elements in the precipitates confirm their coprecipitation reported in the literature [25,26]. The progression of oxidative ozone precipitation as a function of time is illustrated in FIG. 5. Immediately after ozone injection into the treated AMD, the solution's color turned yellow, followed by light and dark brown colors after a couple of hours. The color change of the solution implies that a high Co and Mn recovery and grade could be obtained through control of the reaction time. In a later example, a kinetic study was conducted to obtain kinetic rates of Co and Mn precipitation and coprecipitation of other elements, which provides more insight into how to obtain high grade products and determine process scale-up parameters.

Proposed process for the recovery of Co—Mn from AMD. Ozone was found to be the most efficient oxidizing agent for the recovery of Co and Mn. It also offers an environmentally friendly, chemical-less precipitation of these elements. In addition, it could recover other critical elements like Ni, Pb, Cu, Mn, if present in aqueous solutions such as AMD. The highest Co and Mn recovery and grade from the AMD sample was also obtained through oxidative ozone precipitation. Therefore, it was further investigated for utilization in the AMD treatment process.

For this purpose, ozone was also purged into the original AMD sample to study the potential for the precipitation of Co and Mn at the initial stage and removal of the aeration step. The results were then compared to those of purging ozone into the treated AMD (i.e., pH 7) obtained from the two-staged carbonate precipitation process. Data (shown in Table 3) revealed no significant differences for Co—Mn recovery when ozone was purged into either the original AMD (i. e., pH 3.5) or the treated AMD at pH 7. However, by purging ozone in the original AMD, there was a 28% loss of REEs (mainly Sc with 30% recovery, and Ce with 90% recovery) in the corresponding precipitate product. A similar discrepancy between Ce behavior in natural and synthetic systems was observed for Ce sorption on Mn oxides, where pronounced Ce oxidation occurred in synthetic systems, but was found to be minor in natural systems. If the AMD sample does not have significant REEs, ozone purging in the original AMD is preferred since it can avoid the aeration step. However, if the REEs content of AMD is significant (similar to that of AMD used in this study), ozone should be purged after recovery of Al and REEs. Therefore, the previous two-stage carbonate precipitation process was modified by including ozone injection at pH 7, i.e., after the recovery of REEs [57,34,11].

TABLE 3
Results of cumulative recovery/grade
for Co—Mn using different agents

| | Cobalt | | Manganese | |
|---|---|---|---|---|
| | Recovery | grade | Recovery | grade |
| Ozone purging Stage | (%) | (%) | (%) | (%) |
| Original AMD (pH 3.5) | 95 | 1.2 | 95 | 57.2 |
| Treated AMD (pH 7) | 99 | 0.9 | 98 | 54.6 |

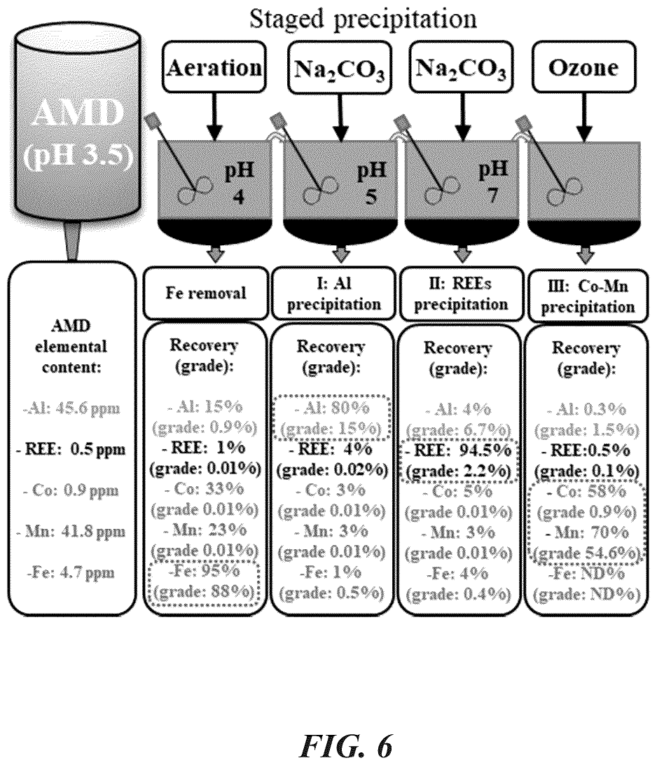

The tested three-stage precipitation process, along with the corresponding critical elements recovery data at each stage, is presented in FIG. 6. In this process, AMD is first aerated to oxidize Fe followed by its precipitation at an approximate pH of 4. The process will be followed by the three-stage precipitation process. The solution pH will be increased to pH 5 and 7 by using carbonate ligands (i.e., Na₂CO₃ or through CO₂ mineralization) for selective recovery of Al, and REEs, respectively. In the third stage, ozone was purged to recover Co and Mn. This process resulted in the removal of >95% Fe at pH 4, 80% Al at pH 5, and 94.5% REEs recovery at pH 7. The remaining Co and Mn in the solution were completely recovered by injection of ozone to the treated AMD, resulting in achieving greater than 98% overall recovery of these elements, and a product with 54.6% Mn and 0.9% Co was obtained.

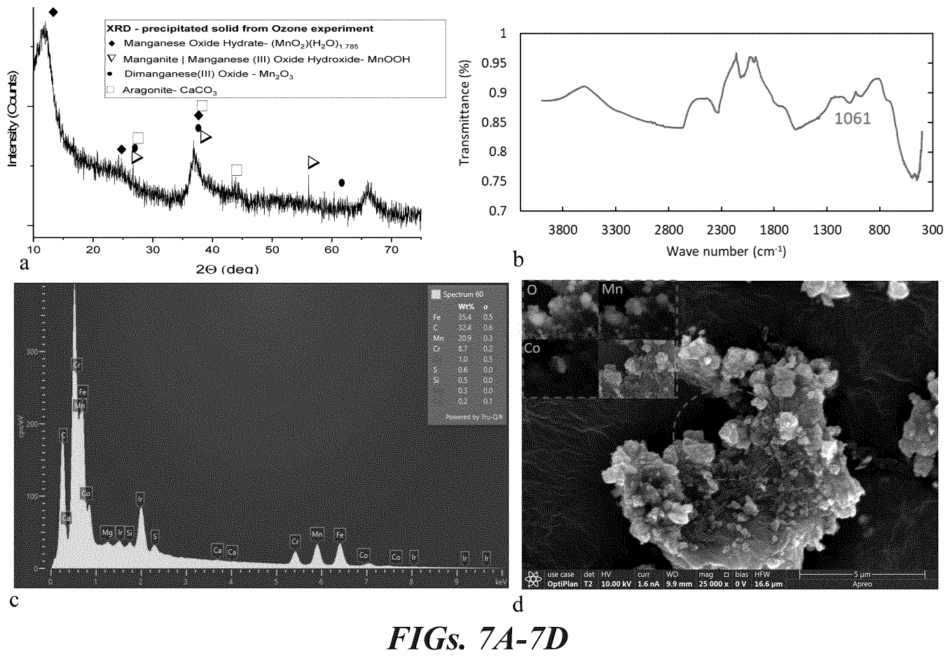

The Co—Mn precipitate product of ozone precipitation was characterized using SEM-EDS and XRD (FIGS. 7A-7D). The SEM-EDS images showed that most of the Co—Mn precipitated particles were in the submicron size with irregular particles having rough surfaces (FIG. 7D). XRD results revealed that Mn precipitates were in the forms of manganese oxide hydrate (MnO₂·H₂O), manganese oxyhydroxide (MnOOH), and trimanganese tetraoxide (Mn₃O₄) (FIG. 7A). These forms of Mn were also confirmed by the FT-IR analysis. The FT-IR spectra showed a strong absorption bond at around 528 cm⁻¹ which is attributed to the Mn—O bond in the MnO₂ and Mn₃O₄ structures. The bonds around 1061 cm⁻¹ and 1620 cm⁻¹ are attributed to the O—H bonding vibration joined with Mn atoms. As one of the major impurities, Ca was found to be in the form of aragonite (CaCO₃). XRD found no sharp peak of Co due to its relatively low concentration. There has been a discussion in the literature on the adsorption of Co to MnO₂ in the precipitation process. However, the SEM micrographs and EDS mapping data showed independent precipitation of Co from Mn (FIGS. 7C-7D).

Conclusions. Through experimental and solution chemistry studies, the effects of various ligands and oxidants on the precipitation of Co and Mn as a function of pH and Eh were investigated to develop a process for the recovery of these critical elements from AMD. Various ligands, including OH⁻, CO₃²⁻, NH₄⁺, SO₄²⁻, and PO₄³⁻ provided by different chemicals, and Na₂S₂O₈, KMnO₄, and 03 oxidative agents were studied. Among the ligands, NH₄OH resulted in the highest recovery (>98%) and grade (0.9% Co and 28% Mn) at pH 9 while offering a low chemical consumption, cost, and toxicity. Among the oxidizers, O₃ resulted in the highest recovery (>98%) and grade (0.9% Co and 54.6% Mn) while offering chemical-free oxidative precipitation of these elements at pH values up to 7. The Mn precipitates obtained from the oxidative ozone precipitation were in the forms of MnO₂·H₂O, MnOOH, and Mn₃O₄. Based on the experimental findings and precipitation patterns of Al, REEs, Co, and Mn, a staged precipitation process was designed for the selective recovery of these elements while neutralizing AMD to mitigate the environmental concerns. Using this proposed three-stage process, more than 95% of Co—Mn and 90% of REEs and Al were recovered selectively in the various stages of the process.

### Example 2. Oxidative Precipitation of Cobalt and Manganese Using Ozone; a Parametric Study

To determine the key factors impacting the oxidative precipitation of Co—Mn, a statistically designed parametric study using BOX-Behnken method was performed. The experimental program evaluated the effects of gas flow rate (oxygen or air at the inlet of an ozone generator), stirring rate, and temperature.

Box Behnken Design parameter for Oxidation of Co and Mn using ozone was as follows: gas flow rate (200, 1100, 2000 cc/minute), stirring rate (0, 400, 800 rpm), and temperature (20, 50, 80° C.).

In this example, two separate pure stock solutions were prepared, one contained 10 ppm of Co and the second one had 50 ppm Mn, which was representative of the concentration of these elements in AMD. A total number of 34 experiments was performed based on the three-level experimental design. Two separate setups for Co—Mn were used and dissolved ozone in the solutions was measured (FIG. 5).

As for Cobalt, the effect of process parameters including gas flow rate, stirring rate, and temperature on the oxidative precipitation of Co using ozone was studied.

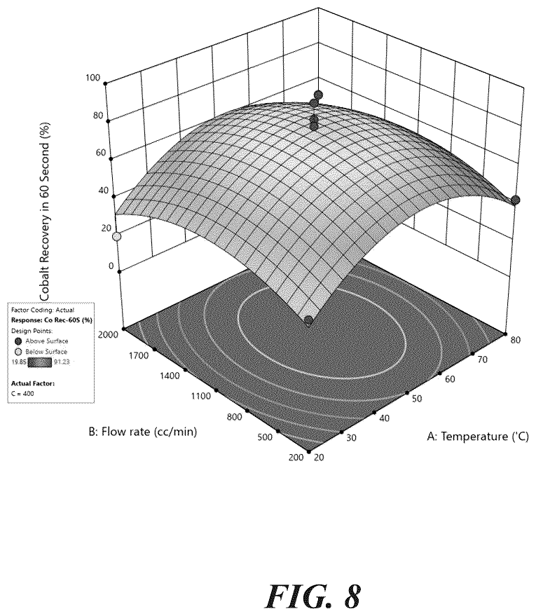

The model was significant, and also lack of fit was not significant. Temperature and gas flow rate were the significant parameters on the recovery of Co. As it can be seen from the surface response plot (FIG. 8), the recovery of Co first increased and then decreases by increasing the gas flow rate and temperature. The optimum condition for Co recovery was found to be a gas flow rate of 1100 ml/min, and temperature of 50° C. The analysis of variance for Co recovery is shown in Table 4.

As for Mn, the model was also significant, and the lack of fit was not significant. Temperature and its interactive effect with gas flow rate, as well as the interactive effect of gas flow rate and stirring rate were the significant parameters on the recovery of Mn.

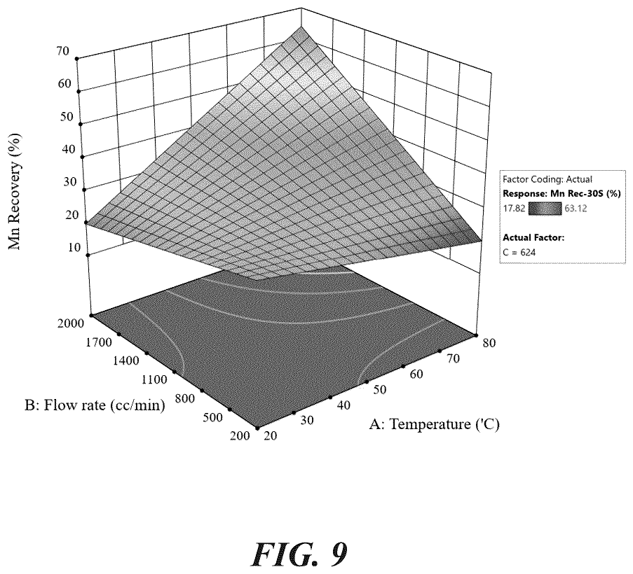

As can be seen from the surface response plot (FIG. 9), by increasing temperature and flow rate, Mn recovery increases. The optimum condition for Mn recovery was obtained at the gas flow rate of 700 ml/min, and temperature of 80° C. The analysis of variance for Co recovery is shown in Table 5.

TABLE 4
Analysis of variance for Co recovery

| | Sum of | | Mean | | | |
|---|---|---|---|---|---|---|
| Source | Squares | df | Square | F-value | p-value | |
| Model | 4303.47 | 4 | 1075.87 | 9.11 | 0.0013 | significant |
| A-Temp | 86.00 | 1 | 86.00 | 0.7285 | 0.4101 | |
| B-Flow | 0.5101 | 1 | 0.5101 | 0.0043 | 0.9487 | |
| rate | | | | | | |
| A2 | 3027.98 | 1 | 3027.98 | 25.65 | 0.0003 | |
| B2 | 984.15 | 1 | 984.15 | 8.34 | 0.0136 | |
| Residual | 1416.72 | 12 | 118.06 | | | |
| Lack of | 1094.95 | 8 | 136.87 | 1.70 | 0.3190 | Not |
| Fit | | | | | | significant |
| Pure Error | 321.77 | 4 | 80.44 | | | |
| Cor Total | 5720.19 | 16 | | | | |

TABLE 5
Analysis of variance for Mn recovery

| | Sum of | | Mean | | | |
|---|---|---|---|---|---|---|
| Source | Squares | df | Square | F-value | p-value | |
| Model | 1887.33 | 5 | 377.47 | 4.37 | 0.0196 | significant |
| A-Temp | 501.81 | 1 | 501.81 | 5.80 | 0.0347 | |
| B-Flow rate | 16.16 | 1 | 16.16 | 0.1869 | 0.6739 | |
| C-Stirring | 56.13 | 1 | 56.13 | 0.6491 | 0.4375 | |
| rate | | | | | | |
| AB | 798.63 | 1 | 798.63 | 9.24 | 0.0113 | |
| BC | 514.61 | 1 | 514.61 | 5.95 | 0.0328 | |
| Residual | 951.13 | 11 | 86.47 | | | |
| Lack of Fit | 550.62 | 7 | 78.66 | 0.7856 | 0.9348 | Not significant |
| Pure Error | 400.51 | 4 | 100.13 | | | |
| Cor Total | 2838.47 | 16 | | | | |

The differences in the behavior of Mn and Co at high temperatures may be due to a combination of factors, including differences in solubility, different reaction rates, the significance of oxygen and ozone in promoting precipitation, the concentration of the metal ions in the solution, and the presence of other ions or compounds in the solution.

In the next example, the oxidation precipitation of Co and Mn in a stock solution by ozone is reported. Various factors (temperature, stirring rate, gas flow rate, and initial ion concentration) affecting the oxidative precipitation rate are investigated comprehensively, and the kinetics equation is established.

The oxidation process relies on temperature, which significantly impacts the mass transfer of ozone in an aqueous solution. Throughout the experiment, parameters such as a stirring rate of 400 cc/min, gas flow rate of 1100 ml/min, and a pH of 7 remained constant.

In this example, three different kinetic models were explored from the results of Co—Mn precipitation. The Linear model (Eq. 3) assumes a first-order reaction with uniform ozone concentration, the Higbie model (Eq. 4) considers mass transfer limitations, and the Pseudo-homogeneous model (Eq. 5) combines both the Linear and Higbie models to consider both homogeneous and mass transfer limitations. Activation energy is measured to gain a better understanding of the precipitation mechanism of Co—Mn by using Eq. 6.

$$\frac{{C}_{t}}{{C}_{o}} = k \times t \qquad ( Eq . 3 )$$

$$ln ( {C}_{t} ) = 2 {k}^{′} {t}^{0.5} + ln ( {C}_{i} ) \qquad ( Eq . 4 )$$

$$ln ( \frac{{C}_{t}}{{C}_{0}} ) = - {k}^{″} \times t \qquad ( Eq . 5 )$$

$${k}_{g} = A exp ( - {E}_{g} / RT ) \qquad ( Eq . 6 )$$

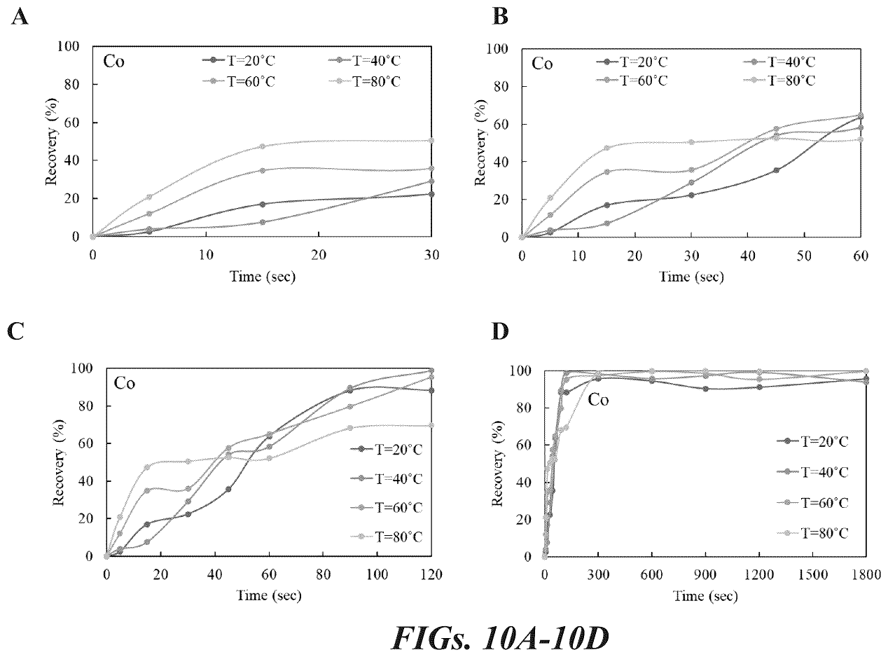

Temperature is a significant parameter for the oxidative precipitation of Co—Mn. FIGS. 10A-10D demonstrate the recovery of Co in the solution as a function of temperature over time. The results show a number of features. First, the precipitation reaction is very fast; in the first minute, more than 50% of Co ions in the solution were precipitated. Second, the recovery of Co first increased and then decreased by increasing temperature. Third, there are intermediate phases in the early moments of the reaction, which make the kinetics mechanism complicated.

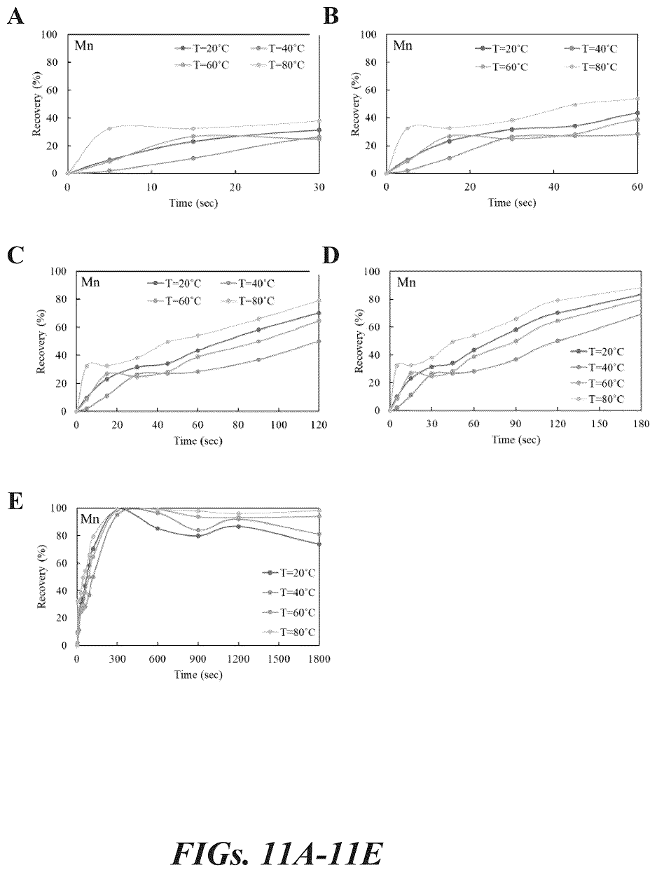

FIGS. 11A-11E demonstrate the recovery of Mn in the solution as a function of temperature over time. The results show that the precipitation reaction is very fast, and the highest recovery, about 95%, was achieved in 5 minutes, and the recovery was further increased by increasing the temperature.

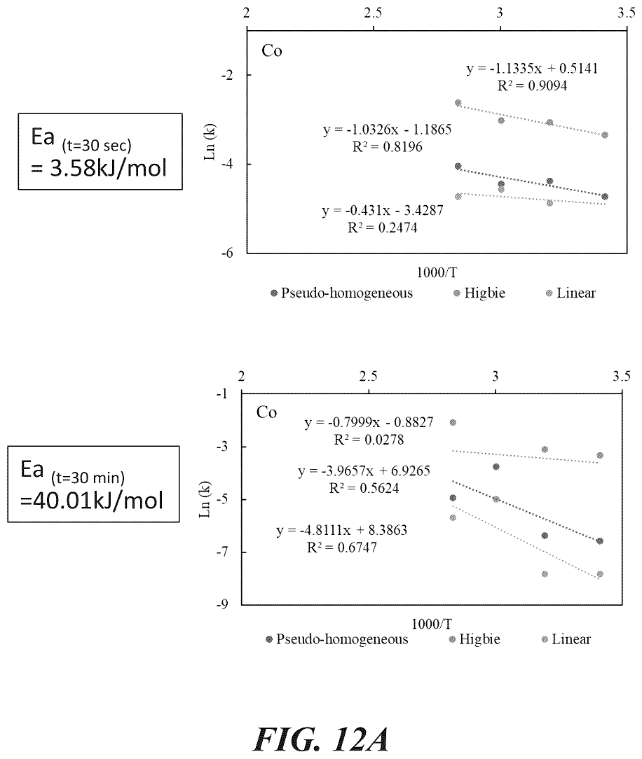

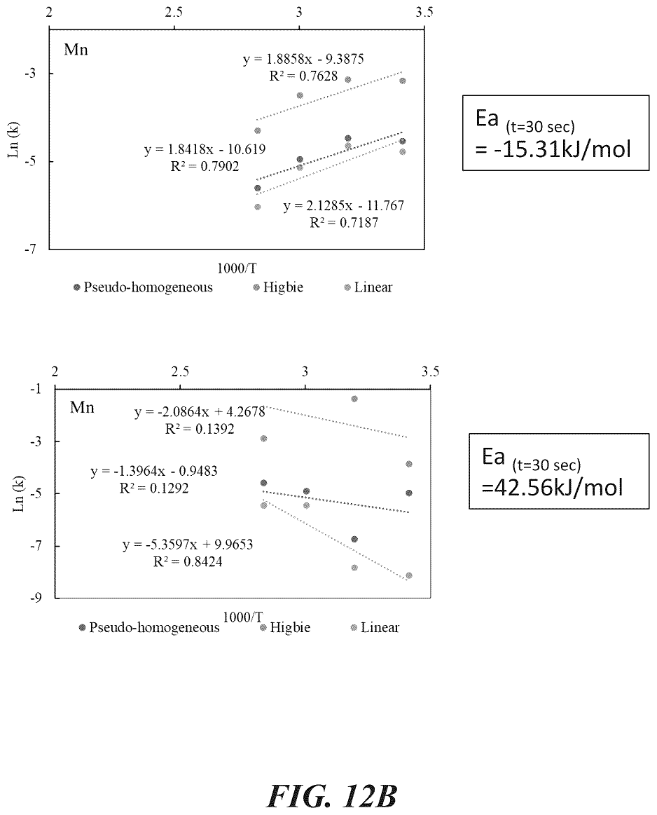

The kinetic rate and activation energy of the reaction were calculated in short and long time periods by using three kinetics models and found that Pseudo-homogenous most appropriately described the reaction (FIGS. 12A and 12B).

It is difficult to provide a specific mechanism for Co—Mn precipitation using ozone because other phenomena play roles, making the process more complicated. For example, mass transfer of ozone plays a significant role as it continuously injects into the reaction throughout the process. Therefore, two short and long-time kinetics rates and activation energy for both Co and Mn were determined, as in the early moments of the reaction the rate of nucleation is very fast, and afterwards the precipitation growth starts at a much faster rate than nucleation. As shown in FIGS. 12A and 12B, activation energy values for Co—Mn indicate that the process is more likely a diffusion-controlled reaction for both elements (FIGS. 12A and 12B). This implies that the rate at which ozone molecules diffuse to, possibly, the surface of the Co and Mn particles, largely determines the reaction rate. Therefore, mass transfer of ozone plays a critical role in oxidative precipitation of Co—Mn.

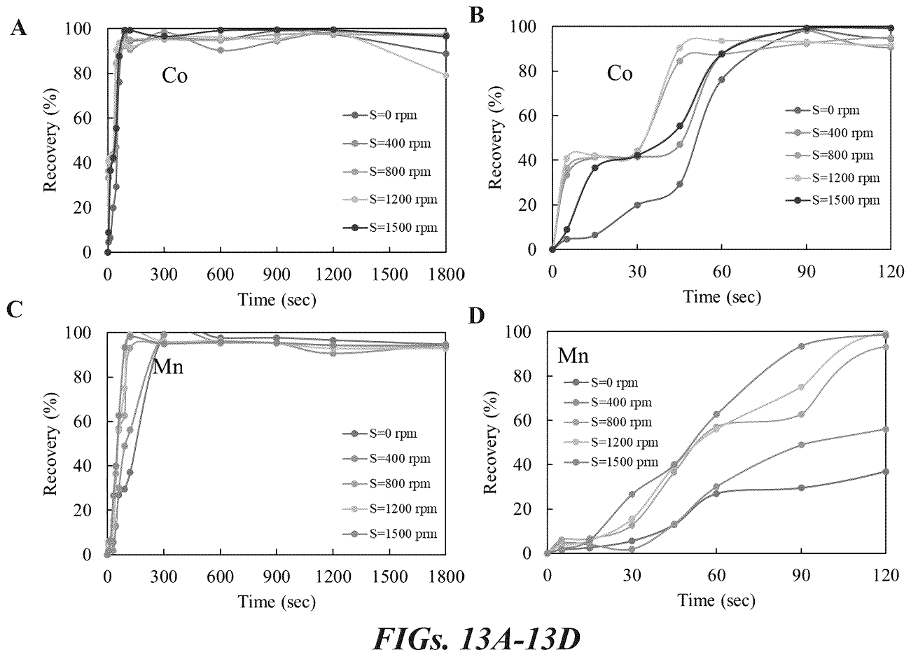

The stirring rate is another important parameter in the oxidation process. Throughout the experiment, the parameters of 25° C. temperature, an ozone flow rate of 250 mL/min, and a pH of 7.0 remained constant. FIGS. 13A-13D illustrate that as the stirring rate increases, the concentration of Co—Mn in the solution decreases at a faster rate. In other words, a higher stirring speed significantly improves the recovery of Co—Mn precipitation. However, very high stirring rate has a negative effect on the recovery of Co (FIGS. 13A and 13B).

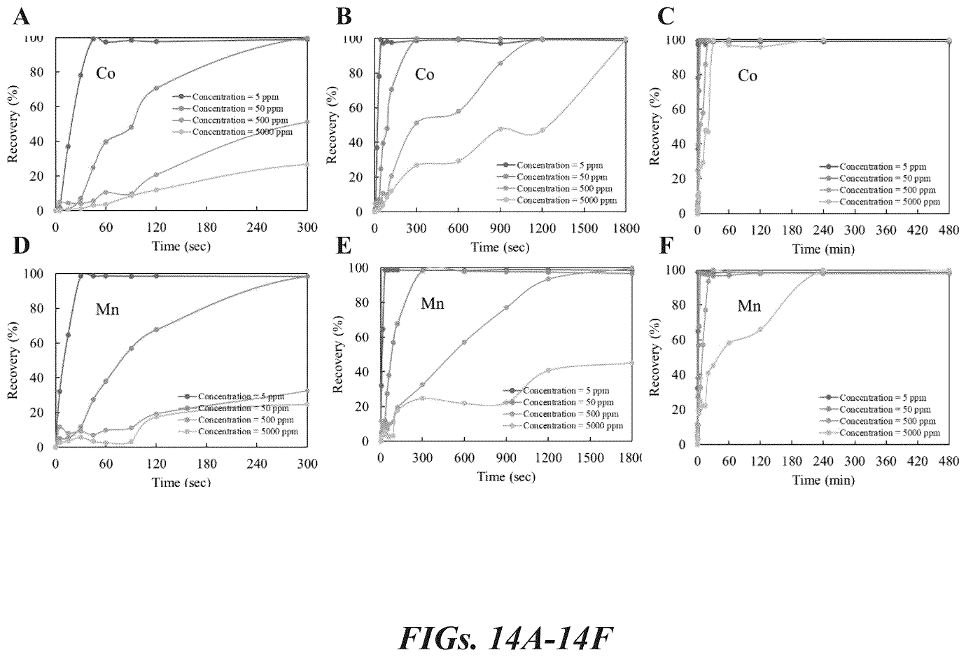

In this study, the effect of ion concentration on the recovery of Co and Mn was also investigated. The experimental conditions included a temperature of 25° C., pH 7, and a stirring speed of 1500 rpm, and flow rate of 1400 cc/min. As depicted in FIGS. 14A-14F, it is evident that it requires approximately 1 minute for Co to fully precipitate when the initial Co concentration is 0.01 mM. However, when initial concentration is increased to 100 mM, the complete reaction of cobalt occurs within 1 hour. On the other hand, a similar trend was observed for Mn but it took longer for Mn to complete precipitate (i.e., 4 hours for 100 mM), therefore rate of precipitation for Co is faster than Mn.

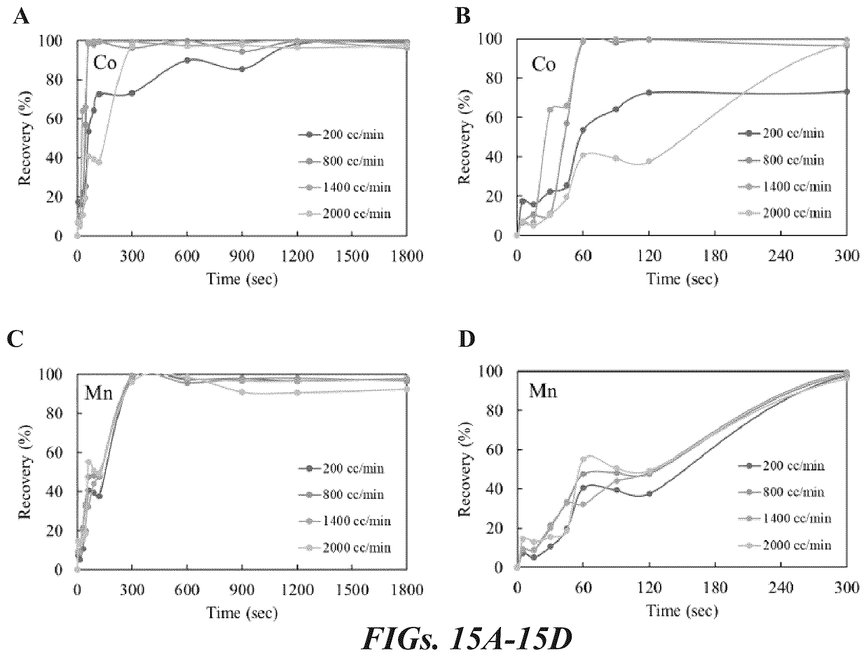

Gas flow rate (oxygen flow rate) also has an important effect on the oxidative precipitation of Co and Mn using ozone. Throughout the experiment, the condition of 25° C., pH of 7, and a stirring speed of 400 rpm remained constant. FIGS. 15A-15D demonstrates the recovery of Co and Mn from the solution as a function of flow rate over time. It is evident that it requires approximately 20 minutes for Co to fully precipitate when the O₂ flow rate is set at 200 mL/min. However, when the O₂ flow rate is increased to 2000 mL/min, the complete reaction of cobalt occurs within 5 minutes. Increasing the flow rate from 1400 to 2000 cc/min led to a reduction in the recovery of both Co (in the first 3 minutes) (FIGS. 15A and 15B).

On the other hand, It is evident that it requires approximately five minutes for Mn to fully precipitate when the O₂ flow rate is set at 200 and 2000 mL/min (FIGS. 15C and 15D). However, the recovery slightly increases for higher flow rates in the first 3 minutes.

### Example 3. Purification-Selective Oxidative Precipitation

In another example, purification and selective separation of Co and Mn by potential control oxidation using ozone from different aqueous solutions (Stock solution, AMD/Sludge, and E-waste) were investigated.

Co and Mn can be selectively precipitated and purified by ozone oxidative precipitation through the control of oxidation-reduction potential (ORP). Ozone, being a powerful oxidizing agent, plays a crucial role in the oxidation process. It promotes the conversion of Co and Mn species into their respective higher oxidation states, facilitating their subsequent precipitation or extraction.

pH control and ORP (Oxidation-Reduction Potential) are important factors in selectively recovering critical elements from an aqueous solution. They can influence the speciation and solubility of the elements, allowing for selective separation of target elements.

Controlling the ORP and pH during the oxidation process enables to selectively precipitate either Co or Mn for purification. The oxidation potential can be adjusted to preferentially oxidize one metal while leaving the other in a lower oxidation state. This allows the separation of Co and Mn from the aqueous solution based on their distinct oxidation behaviors.

The solubility of many metal ions is pH-dependent. By controlling the pH of the solution, it is possible to induce the precipitation of specific metal ions as insoluble compounds. Adjusting the pH to a specific range can promote the formation of desired precipitates while keeping other elements in the solution.

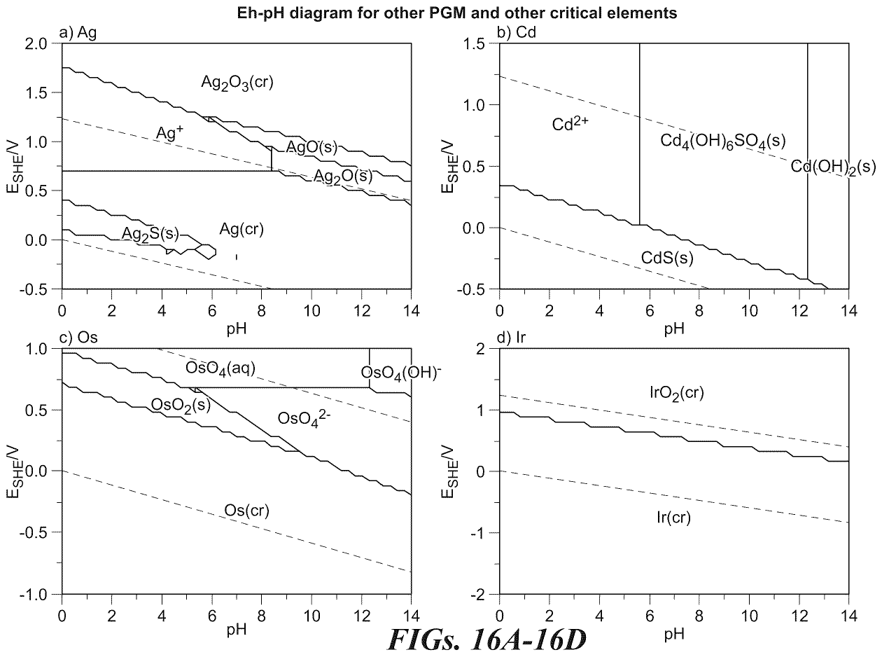

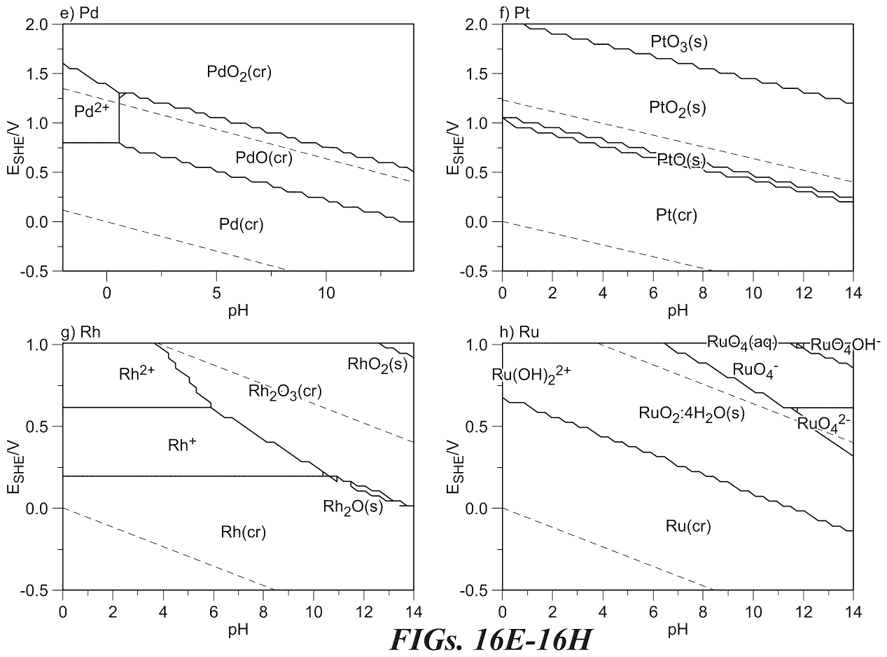

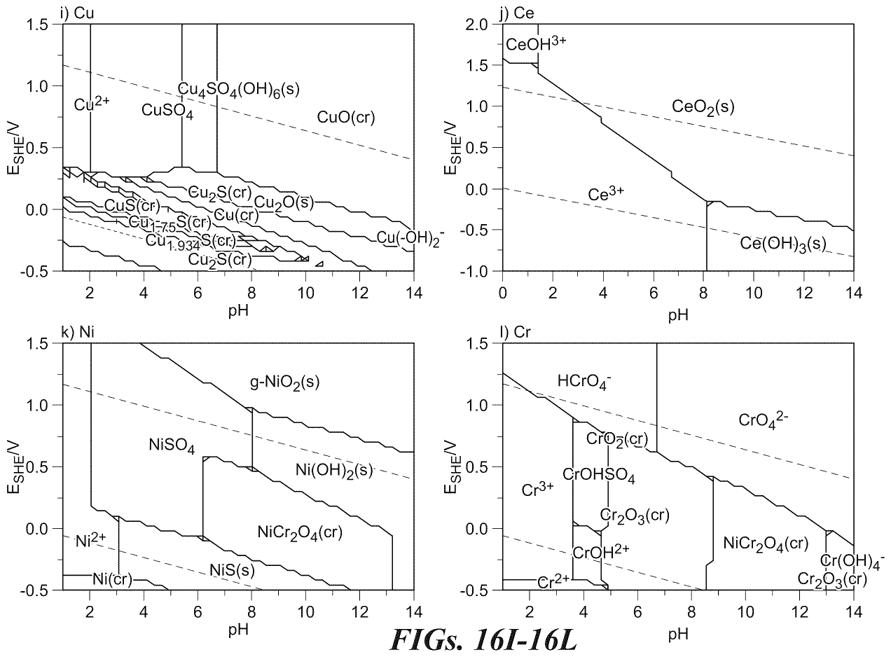

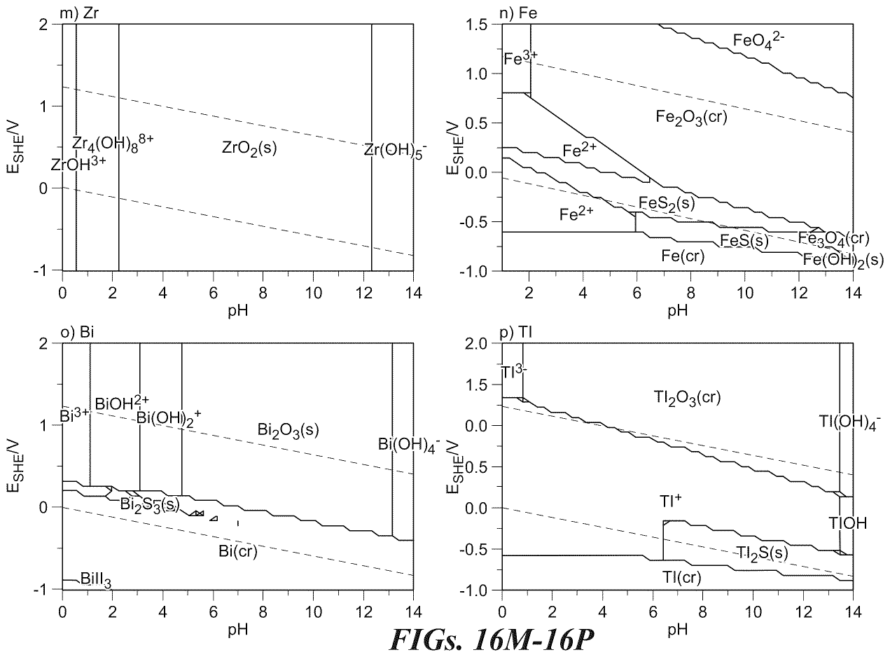

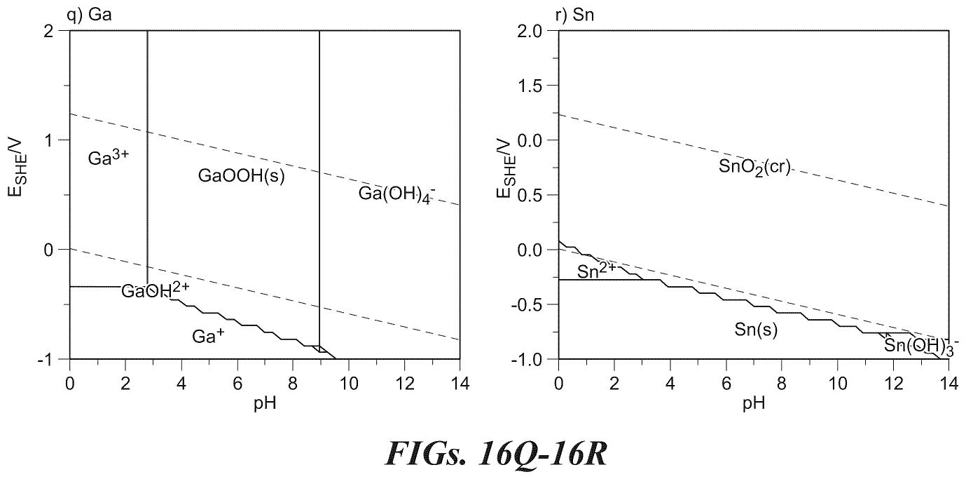

ORP also plays a crucial role in the selective separation of Co and Mn during potential control oxidation by ozone. ORP is a measurement of the tendency of a solution to undergo oxidation or reduction reactions. It provides valuable information about the oxidizing or reducing power of a system. In the context of selective separation, ORP is used to control the oxidation potential during the oxidation process. By adjusting the ORP, it is possible to selectively target and oxidize one metal while minimizing the oxidation of the other. This differential oxidation behavior is essential for the successful separation of Co and Mn. By carefully controlling the ORP, the selective separation of Co and Mn is achieved. It ensures that one metal is effectively separated from the solution while minimizing unwanted reactions or losses of the other metal. ORP monitoring and adjustment are, therefore, critical in achieving successful and efficient selective separation during potential control oxidation processes. The preliminary results of the selective separation of critical elements from different aqueous solutions are promising. Moreover, recovery of precious elements, other critical elements (including Ni, Cu, Cd, Cr, Zr, Bi, Tl, Ga, and Sn), Ce, and Fe can be achieved by ozone oxidative precipitation. FIGS. 16A-16R present Eh-pH diagrams illustrating the conditions for various metallic elements that undergo the formation of insoluble compounds when subjected to ozone oxidative precipitation.

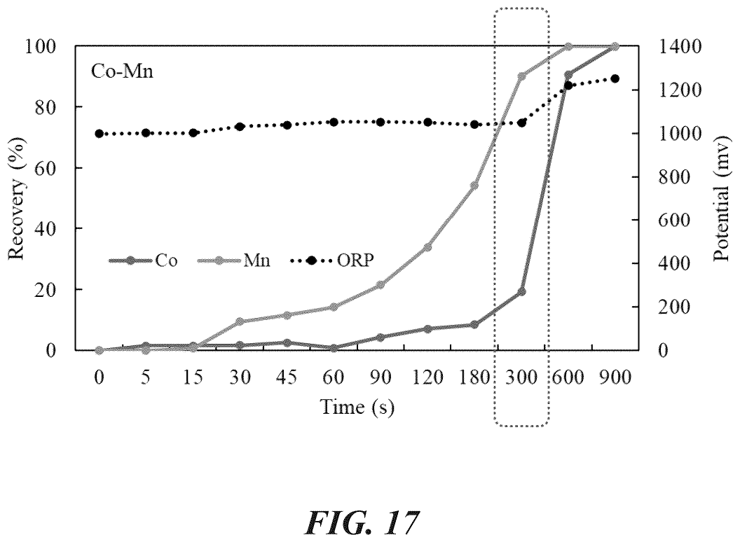

Co—Mn stock solution. In this example, the concentrations of Mn and Co, as well as the system's ORP, were measured periodically. The experiment was conducted at a temperature of 25° C., a pH value of 4.0, a stirring speed of 1500 rpm, and a gas flow rate of 1100 cc/min. The findings of this experiment are depicted in FIG. 17. In the first step, separating Mn was targeted, resulting in a rapid decrease in its concentration within the first 300 seconds. Meanwhile, the concentration of Co remained relatively stable with minimal recovery (about 20%). In the next step, the Co recovery was completed in the next 300 seconds to precipitate from the aqueous solution. The purity can be further improved through pH adjustment, combined with ORP control.

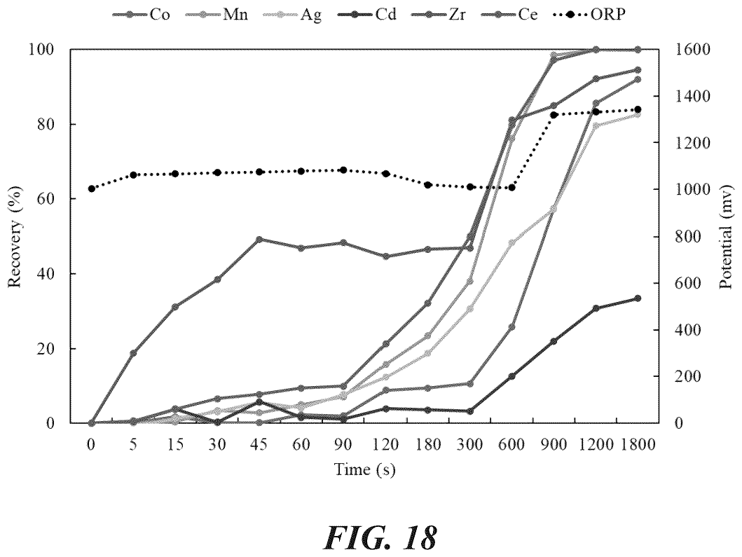

AMD/Sludge AMD/Sludge. AMD sludge was leached and the leachate was processed by ozone precipitation to recover elements. The concentrations of Co, Mn, Ag, Cd, Zr and Ce, as well as the system's ORP were measured periodically in purification of AMD-sludge leachate solution. The experiment was conducted at the temperature of 25° C., pH value of 4.0, stirring speed of 1500 rpm, and a gas flow rate of 1100 cc/min. The findings of this experiment are depicted in FIG. 18. As can be seen, Co and Mn have a similar trend to FIG. 17 for selective separation. Moreover, the separation of Ag, Cd, Zr, and Ce can be performed by oxidative precipitation using ozone. The purity of the target elements can be further improved by combined control of pH and ORP values determined based on presented pH-Eh diagrams in FIGS. 16A-16R using ozone oxidative precipitation.

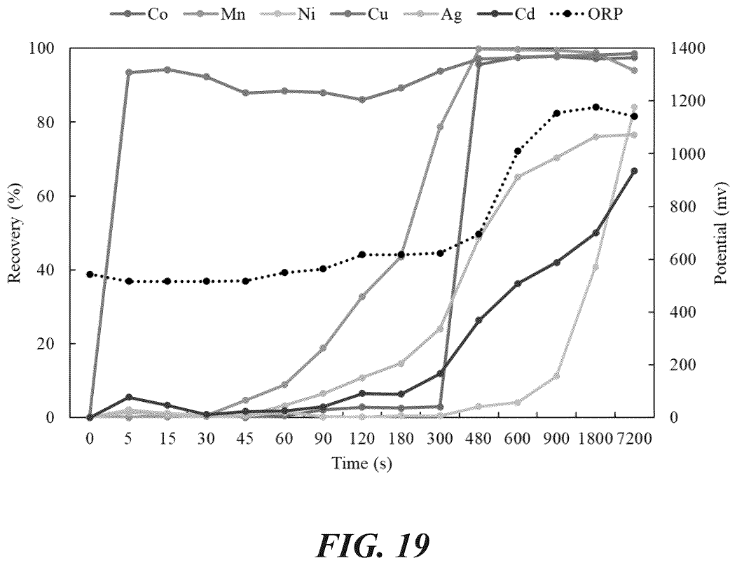

Separation of elements from a leaching solution obtained by processing electronic waste. In this example, the leachate obtained by leaching of electronic waste (waste printed circuit boards) using sulfuric acid was subjected to staged precipitation to recover metals at pH 7, and ozone was introduced to the leachate. The concentrations of Co, Mn, Cu, Ag, Ni and Cd, as well as the system's ORP, were measured periodically. The experiment was conducted at a temperature of 25° C., a pH value of 7.0, a stirring speed of 1500 rpm, and a gas flow rate of 1100 cc/min in a leaching solution obtained by processing electronic waste. The findings of this experiment are depicted in FIG. 19. In the first step, separating Cu was targeted, resulting in a rapid decrease in its concentration within the first 5 seconds. Meanwhile, the concentration of other elements including Mn, Ni, Co, Ag, and Cd remained relatively stable with minimal recovery (less than 5%). In the next step, the Mn recovery was obtained in 300 seconds (recovery >80%) while other elements were retained in the solution. In the next 2 minutes Co recovery was performed (recovery >95%). Afterward, about 70% of Ag and 40% of Cd were recovered from the solution in 15 minutes, while the majority content of Ni remained in the aqueous solution. In the last step, Ni was recovered from the remained solution within 2 hours (recovery >80%). This result shows that selective separation of Co, Mn, Cu, Ag, Cd, and Ni can be performed through potential control oxidation using ozone and utilizing the differences in the precipitation rate of the elements. Combining the process with controlling pH can even further enhance the separation efficiency.

### EXEMPLARY ASPECTS

Exemplary aspect 1. A method of removing dissolved metals from an aqueous solution, the method comprising: a) mixing ozone into the aqueous solution thereby forming dissolved metal precipitates; and b) removing dissolved metal precipitates.

Exemplary aspect 2. The method of exemplary aspect 1, the method further comprising: c) measuring a concentration of dissolved metals, Eh, and pH of the aqueous solution; and d) repeating steps a) to c) until the measured concentration of dissolved metals does not substantially change.

Exemplary aspect 3. The method of exemplary aspects 1 or 2, wherein the aqueous solution comprises one or more dissolved metals Co, Mn, Ni, Cu, Ag, Cd, Zr, Ce, Os, Ir, Pd, Pt, Rh, Ru, Cr, Fe, Bi, Ga, Sn, and/or Tl.

Exemplary aspect 4. The method of any one of exemplary aspects 1-3, the method comprising removing Fe, Al, Ca, Mg, Na, P, and/or rare earth metals before mixing ozone into the aqueous solution.

Exemplary aspect 5. The method of any one of exemplary aspects 1-3, the method comprising removing Fe, Al, Ca, Mg, Na, P, and/or rare earth metals after step d).

Exemplary aspect 6. The method of any one of exemplary aspects 1-5, wherein ozone is mixed into the aqueous solution at a predetermined flow rate.

Exemplary aspect 7. The method of any one of exemplary aspects 1-6, wherein the aqueous solution is at a temperature of about 0-80° C. during steps a) to d).

Exemplary aspect 8. The method of any one of exemplary aspects 1-7, wherein a flow rate of ozone is varied when steps a) to c) are repeated.

Exemplary aspect 9. The method of any one of exemplary aspects 1-8, wherein a temperature of the aqueous solution is varied when steps a) to c) are repeated.

Exemplary aspect 10. The method of any one of exemplary aspects 1-9, wherein steps a) to c) are repeated until the measured pH is about 8.0.

Exemplary aspect 11. The method of any one of exemplary aspects 1-10, wherein the aqueous solution has a pH of about 0-12.

Exemplary aspect 12. The method of any one of exemplary aspects 1-11, wherein the aqueous solution comprises acid mine drainage, mine-influenced water, industrial wastewater, brines, geothermal brine, oil and gas produced water and wastewater, sludge leachate, electronic waste recycling leachate, battery recycling leachate, solar panel recycling leachate, leachate/pregnant leaching solution obtained from processing ores and any other primary and secondary sources of the metals, or other aqueous waste comprising Co, Mn, Ni, Cu, Ag, Cd, Zr, Ce, Os, Ir, Pd, Pt, Rh, Ru, Cr, Fe, Bi, Ga, Sn, and/or Tl.

Exemplary aspect 13. The method of any one of exemplary aspects 1-12, wherein the dissolved metals form precipitates, wherein the precipitates are Co, Mn, Ni, Cu, Ag, Cd, Zr, Ce, Os, Ir, Pd, Pt, Rh, Ru, Cr, Fe, Bi, Ga, Sn, and/or Tl precipitates.

Exemplary aspect 14. The method of exemplary aspect 13, wherein about 50-99% of the dissolved metals from the aqueous solution are recovered as precipitates.

Exemplary aspect 15. The method of exemplary aspect 14, wherein the precipitates of the dissolved metals are purified for secondary uses.

Exemplary aspect 16. A method of recovery of dissolved metals from an acid mine drainage stream, the method comprising: a) removing Fe; b) removing Al; c) removing REEs; d) mixing ozone into the acid mine drainage stream at a rate thereby forming precipitates of dissolved metals; e) separating the precipitates of the dissolved metals; f) measuring a concentration of dissolved metals and pH of the acid mine drainage stream; and g) repeating steps d)-f) until the measured concentration of the dissolved metals does not change.

Exemplary aspect 17. The method of exemplary aspect 16, wherein Fe is removed by aeration or chemical precipitation.

Exemplary aspect 18. The method of any one of exemplary aspects 16-17, wherein Al is removed by chemical precipitation at low pH.

Exemplary aspect 19. The method of any one of exemplary aspect 16-18, wherein rare earth elements are removed by chemical precipitation at acidic or neutral pH.

Exemplary aspect 20. A method of purification or selectively removing dissolved metals from an aqueous solution, the method comprising: a) adjusting a pH of the aqueous solution to a predetermined pH; b) flowing ozone into the aqueous solution to achieve a predetermined oxidation-reduction potential and stirring the aqueous solution for a predetermined period of time, thereby forming a first solid metal fraction; c) separating the first solid metal fraction; and d) repeating steps a)-c) for a second or more solid metal fraction.

Exemplary aspect 21. The method of exemplary aspect 20, wherein one of the first, second or more solid metal fraction comprises the dissolved metals, wherein the dissolved metals are one or more of Co, Mn, Ni, Cu, Ag, Cd, Zr, Ce, Os, Ir, Pd, Pt, Rh, Ru, Cr, Fe, Bi, Ga, Sn, and/or Tl.

Exemplary aspect 22. The method of exemplary aspects 20 or 21, wherein the predetermined pH is in a range of about 0 to about 8.

Exemplary aspect 23. The method of any one of exemplary aspects 20-22, wherein the aqueous solution is a brine, waste waters of mine, oil and gas industry, or a leachate obtained by processing ores, processing secondary sources, processing waste, processing sludge, processing precipitates, or recycling electronic waste, battery, and solar panel.

Exemplary aspect 24. The method of any one of exemplary aspects 20-23, wherein about 50-99% of metals from the first, second, or more solid metal fraction of the aqueous solution are recovered.

### REFERENCES

[1] P. L. Rozelle, N. Mamula, B. J. Arnold, T. O'Brien, M. Rezaee, S. V. Pisupati, Secondary cobalt and manganese resources in Pennsylvania: quantities, linkage with mine reclamation, and preliminary flowsheet evaluation for the U.S. domestic lithium-ion battery supply chain Pa. State Univ. Cent. Crit. Miner. 2021.
[2] Rozelle, P. L., Shi, F., Rezaee, M., Pisupati, S. V. (2020). The Pennsylvania State University Center for Critical Minerals.
[3] U.S. Geological Survey. (2022a). Manganese. Mineral commodity summaries.
[4] U.S. Geological Survey. (2022b). Cobalt. Mineral commodity summaries.
[5] Slack, J. F., Kimball, B. E., and Shedd, K. B. (2017). Cobalt, chap. F of Schulz, K. J., DeYoung, J. H., Jr., Seal, R. R., II, and Bradley, D. C., eds., Critical mineral resources of the United States-Economic and environmental geology and prospects for future supply: U.S. Geological Survey Professional Paper 1802, p. F1-F40, https://doi.org/10.3133/pp1802F.
[6] International Energy Agency (IEA). (2021). The role of critical minerals in clean energy transition. World energy outlook special report.
[7] D. B. Johnson, K. B. Hallberg, Acid mine drainage remediation options: a review, Sci. Total Environ. 338 (1-2) (2005) 3-14.
[8] M. Rezaee, F. E. Huggins, R. Q. Honaker, Minimizing the environmental impacts of coal waste disposal, Environ. Consid. Energy Prod. (2013) 60-77.
[9] M. Rezaee, R. C. Warner, R. Q. Honaker, Development of an electrical conductivity screening test for mine waste assessments, Chemosphere 160 (2016) 13-21.
[10] J. G. Skousen, P. F. Ziemkiewicz, L. M. McDonald, Acid mine drainage formation, control and treatment: approaches and strategies, Extr. Ind. Soc. 6 (1) (2019) 241-249.
[11] B. Vaziri Hassas, M. Rezaee, S. V. Pisupati, Effect of various ligands on the selective precipitation of rare earth elements from acid mine drainage, Chemosphere 280 (2021), 130684.
[12] A. Akcil, S. Koldas, Acid mine drainage (AMD): causes, treatment, and case studies, J. Clean. Prod. 14 (12-13) (2006) 1139-1145.
[13] M. Rezaee, R. Q. Honaker, Long-term leaching characteristic study of coal processing waste streams, Chemosphere 249 (2020), 126081.
[14] A. RoyChowdhury, D. Sarkar, R. Datta, Remediation of acid mine drainage-impacted water, Curr. Pollut. Rep. 1 (3) (2015) 131-141.
[15] M. Rezaee, V. N. Rajagopalan, R. Q. Honaker, Conceptual modifications of coal preparation plants to minimize potential environmental issues associated with coal waste disposal, Fuel 250 (2019) 352-361.
[16] National Pollutant Discharge Elimination System (NPDES), 1972. Federal Water Pollution Control Act Amendments of 1972, the Clean Water Act 33 U.S.C. § 1251 et seq.
[17] G. Chen, Y. Ye, N. Yao, N. Hu, J. Zhang, Y. Huang, A critical review of prevention, treatment, reuse, and resource recovery from acid mine drainage, ISSN 0959-6526, J. Clean. Prod. 329 (2021), 129666, https://doi.org/10.1016/j. jclepro.2021.129666.
[18] D. W. Fuerstenau, K. N. Han, Metallurgy and processing of marine manganese nodules, Miner. Process. Extr. Metall. Rev. 1 (1-2) (1983) 1-83, https://doi.org/10.1080/08827508308952589.
[19] Q. Li, W. Zhang, Process development for recovering critical elements from acid mine drainage, ISSN 0921-3449, Resour. Conserv. Recycl. 180 (2022), 106214, https://doi.org/10.1016/j.resconrec.2022.106214.
[20] G. Pozo, S. Pongy, J. Keller, P. Ledezma, S. Freguia, A novel bioelectrochemical system for chemical-free permanent treatment of acid mine drainage, Water Res. 126 (2017) 411-420, https://doi.org/10.1016/j.watres.2017.09.058.
[21] E. Y. Seo, Y. W. Cheong, G. J. Yim, K. W. Min, J. N. Geroni, Recovery of Fe, Al and Mn in acid coal mine drainage by sequential selective precipitation with control of pH, Catena 148 (2017) 11-16.
[22] W. Zhang, C. Y. Cheng, Manganese metallurgy review. Part II: Manganese separation and recovery from solution, Hydrometallurgy 89 (3-4) (2007) 160-177.
[23] A. A. Baba, L. Ibrahim, F. A. Adekola, R. B. Bale, M. K. Ghosh, A. R. Sheik, S. R. Pradhan, O. S. Ayanda, I. O. Folorunsho, Hydrometallurgical processing of manganese ores: a review, J. Miner. Mater. Charact. Eng. 2 (03) (2014) 230.
[24] A. Katsiapi, P. E. Tsakiridis, P. Oustadakis, S. Agatzini-Leonardou, Cobalt recovery from mixed Co—Mn hydroxide precipitates by ammonia-ammonium carbonate leaching, Miner. Eng. 23 (8) (2010) 643-651.
[25] Q. Lin, J. G. Fu, G. Gu, C. Wang, H. Wang, R. F. Zhu, Separation of manganese from calcium and magnesium in sulfate solutions via carbonate precipitation, Trans. Nonferrous Met. Soc. China 26 (4) (2016) 1118-1125.
[26] M. M. Muanda, P. P. D. Omalanga, Modeling and optimization of manganese carbonate precipitation using response surface methodology and central composite rotatable design, J. Eng. Exact. Sci. 7 (3) (2021).
[27] R. M. Freitas, T. A. Perilli, A. C. Q. Ladeira, Oxidative precipitation of manganese from acid mine drainage by potassium permanganate, J. Chem. (2013), 287257.
[28] S. H. Joo, J. Kang, K. Woong, S. M. Shin, Production of chemical manganese dioxide from lithium-ion battery ternary cathodic material by selective oxidative precipitation of manganese, Mater. Trans. 54 (5) (2013) 844-849.
[29] J. Van Rooyen, S. Archer, M. Fox, Manganese removal from cobalt solutions with dilute sulphur dioxide gas mixtures (July)Fourth South. Afr. Conf. Base Met. South. Afr. Inst. Min. Metall. 2007 365 376.
[30] S. M. Park, J. C. Yoo, S. W. Ji, J. S. Yang, K. Baek, Selective recovery of dissolved Fe, Al, Cu, and Zn in acid mine drainage based on modeling to predict precipitation pH, Environ. Sci. Pollut. Res. 22 (2015) 3013-3022, https://doi.org/10.1007/s11356-014-3536-x.
[31] W. Zhang, R. Honaker, Process development for the recovery of rare earth elements and critical metals from an acid mine drainage, Miner. Eng. 153 (2020), 106382, https://doi.org/10.1016/j.mineng.2020.106382.
[32] M. Balintova, A. Petrilakova, Study of pH influence on selective precipitation of heavy metals from acid mine drainage, Chem. Eng. Trans. 25 (2011) 345-350.
[33] Y. Haihe, Z. Tianwen, J. Zhirong, S. Tian, W. Chunguang, Study on the influencing factors and mechanism of calcium carbonate precipitation induced by urease bacteria, J. Cryst. Growth 564 (2021) 1-9.
[34] B. Vaziri Hassas, M. Rezaee, S. V. Pisupati, Precipitation of rare earth elements from acid mine drainage by CO₂ mineralization process, Chem. Eng. J. 399 (2020), 125716.
[35] V. Philippini, T. Vercouter, A. Chauss'e, P. Vitorge, Precipitation of ALn (CO₃)₂, xH₂O and Dy₂ (CO₃)₃, xH₂O compounds from aqueous solutions for A⁺=Li⁺, Na⁺, K⁺, Cs⁺, NH₄⁺ and Ln³⁺=La³⁺, Nd³⁺, Eu³⁺, Dy³⁺, J. Solid State Chem. 181 (9) (2008) 2143-2154.
[36] J. D. Rodriguez-Blanco, B. Vallina, J. A. Blanco, L. G. Benning, The role of REE³⁺ in the crystallization of lanthanites, Mineral. Mag. 78 (6) (2014) 1373-1380.
[37] Bolton, G. L., Sefton, V. B., & Zubryckyj, N. (1981). U.S. Pat. No. 4,290,866.
[38] Sato, M. and Robbins, E. I. (2000). Recovery/removal of metallic elements from acid mine drainage using ozone. Society for Mining, Metallurgy, and Exploration, Proceedings of the 2000 ICARD conference, v. II, p. 1095-1100.
[39] S. J. Tewalt, M. Sato, F. T. Dulong, S. G. Neuzil, A. Kolker, K. O. Dennen, Use of ozone to remediate manganese from coal mine drainage waters Proc. Natl. Meet. Am. Soc. Min. Reclam., 2005, pp. 1166-1176.
[40] Q. H. Tian, X. Y. Guo, Y. I. Yu, Z. H. Li, Kinetics of oxidation-precipitation of cobalt (II) from solution by ozone, Trans. Nonferrous Met. Soc. China 20 (2010) s42-s45.
[41] Q. Tian, Y. Xin, H. Wang, X. Guo, Potential-controlled selective recovery of manganese and cobalt from cobalt slag leaching solution, Hydrometallurgy 169 (2017) 201-206.
[42] Senanayake. G. (2011). Acid leaching of metals from deep-sea manganese nodules—A critical review of fundamentals and applications Miner. Eng., 24 (13) (2011), pp. 1379-1396, 10.1016/j.mineng.2011.06.003.
[43] A. Jones, Enhanced metal recovery from a modified caron leach of mixed nickel-cobalt hydroxide. Doctoral dissertation Murdoch Univ., 2013, pp. 1-179.
[44] J. D. Hem, C. E. Roberson, C. J. Lind, Thermodynamic stability of CoOOH and its coprecipitation with manganese, Geochim. Et Cosmochim. Acta 49 (3) (1985) 801-810.
[45] C. J. Bise, Modern American coal mining: methods and applications. Society for Mining, Metallurgy, and Exploration Inc. Englewood, CO 2013 563.ISBN: 9780873353526. P.
[46] S. J. Clark, J. D. Donaldson, Z. I. Khan, Heavy metals in the environment. Part VI: Recovery of cobalt values from spent cobalt/manganese bromide oxidation catalysts, Hydrometallurgy 40 (3) (1996) 381-392.
[47] R. P. Das, S. Anand, S. C. Das, P. K. Jena, Leaching of manganese nodules in ammoniacal medium using glucose as reductant, Hydrometallurgy 16 (3) (1986) 335-344.
[48] R. S. Dean, Manganese extraction by carbamate solutions and the chemistry of new manganese ammonia complexes, Trans. AIME (1952) 55-60.
[49] K. Osseo-Asare, Application of activity—activity diagrams to ammonia hydrometallurgy-3-Mn—NH₃—H₂O,Mn—NH₃—H₂O—CO₃ and Mn—NH₃—H₂O—SO₄ systems at 25 degree C. Transactions of the Institution of Mining and Metallurgy Sect. C: Miner. Process. Extr. Metall., 90, 1981, pp. 152-158.
[50] C. Drouet, Applied predictive thermodynamics (ThermAP). Part 2. Apatites containing Ni2+, Co2+, Mn2+, or Fe2+ ions, J. Chem. Thermodyn. 136 (2019) 182-189.
[51] S. Mohanty, M. K. Ghosh, V. Chakravortty, S. Anand, Behaviour of cobalt during precipitation of manganese from the NH3-(NH4)2SO4-Mn—O2 system, Hydrometallurgy 42 (3) (1996) 357-366.
[52] B. Vaziri Hassas, Y. Shekarian, M. Rezaee, S. V. Pisupati, Selective recovery of high-grade rare earth, Al, and Co—Mn from acid mine drainage treatment sludge material, Miner. Eng. 187 (2022), https://doi.org/10.1016/j. mineng.2022.107813.
[53] K. C. Nathsarma, P. B. Sarma, Separation of iron and manganese from sulphate solutions obtained from indian ocean nodules, Hydrometallurgy 17 (2) (1987) 239-249.
[54] J. W. Murray, J. G. Dillard, R. Giovanoli, H. Moers, W. Stumm, Oxidation of Mn (II): Initial mineralogy, oxidation state and ageing, Geochim. Et Cosmochim. Acta 49 (2) (1985) 463-470.
[55] J. E. Post, Manganese oxide minerals: crystal structures and economic and environmental significance, Proc. Natl. Acad. Sci. U.S.A. 96 (7) (1999) 3447-3454.
[56] M. Bau, Scavenging of dissolved yttrium and rare earths by precipitating iron oxyhydroxide: experimental evidence for Ce oxidation, Y-Ho fractionation, and lanthanide tetrad effect, Geochim. Et Cosmochim. Acta 63 (1) (1999) 67-77.
[57] M. Rezaee, B. Vaziri, Hassas S. V., Pisupati Recovery of rare earth elements from acidic solutions U.S. Pat., WO2021155224A1. 2021.
[58] M. Rezaee, Y. Shekarian, S. V. Pisupati, Ozone Oxidative Precipitation of Elements from Aqueous Streams U.S. Provisional Pat. Appl. Ser. No. 63/392 2022 330.

1. A method of removing dissolved metals from an aqueous solution, the method comprising:
a) mixing ozone into the aqueous solution thereby forming dissolved metal precipitates;
b) removing the dissolved metal precipitates;
c) measuring a concentration of the dissolved metals, Eh, and pH of the aqueous solution; and
d) repeating steps a) to c) until the measured concentration of the dissolved metals does not substantially change.

2. (canceled)

3. The method of claim 1, wherein the aqueous solution comprises one or more dissolved metals Co, Mn, Ni, Cu, Ag, Cd, Zr, Ce, Os, Ir, Pd, Pt, Rh, Rui, Cr, Fe, Bi, Ga, Sn, and/or Ti.

4. The method of claim 1, the method comprising removing Fe, Al, Ca, Mg, Na, P, and/or rare earth metals before mixing the ozone into the aqueous solution.

5. The method of claim 1, the method comprising removing Fe, Al, Ca, Mg, Na, P, and/or rare earth metals after step d).

6. The method of claim 1, wherein the ozone is mixed into the aqueous solution at a predetermined flow rate.

7. The method of claim 1, wherein the aqueous solution is at a temperature of about 0-80° C. during steps a) to d).

8. The method of claim 1, wherein a flow rate of the ozone is varied when steps a) to c) are repeated.

9. The method of claim 1, wherein a temperature of the aqueous solution is varied when steps a) to c) are repeated.

10. The method of claim 1, wherein steps a) to c) are repeated until the measured pH is about 8.

11. The method of claim 1, wherein the aqueous solution has a pH of about 0-12.

12. The method of claim 1, wherein the aqueous solution comprises acid mine drainage, mine-influenced water, industrial wastewater, brines, geothermal brine, oil and gas produced water and wastewater, sludge leachate, electronic waste recycling leachate, battery recycling leachate, solar panel recycling leachate, leachate/pregnant leaching solution obtained from processing ores and any other primary and secondary sources of the metals, or other aqueous waste comprising Co, Mn, Ni, Cu, Ag, Cd, Zr, Ce, Os, Ir, Pd, Pt, Rh, Ru, Cr, Fe, Bi, Ga, Sn, and/or Ti.

13. The method of claim 1, wherein the dissolved metals form precipitates, wherein the precipitates are Co, Mn, Ni, Cu, Ag, Cd, Zr, Ce, Os, Ir, Pd, Pt, Rh, Ru, Cr, Fe, Bi, Ga, Sn, and/or Tl precipitates.

14. The method of claim 13, wherein about 50-99% of the dissolved metals from the aqueous solution are recovered as the precipitates.

15. The method of claim 14, wherein the precipitates of the dissolved metals are purified for secondary uses.

16. A method of recovery of dissolved metals from an acid mine drainage stream, the method comprising:
a) removing Fe;
b) removing Al;
c) removing rare earth elements (REEs);
d) mixing ozone into the acid mine drainage stream at a rate thereby forming precipitates of dissolved metals;
e) separating the precipitates of the dissolved metals;
f) measuring a concentration of dissolved metals and pH of the acid mine drainage stream; and
g) repeating steps d)-f) until the measured concentration of the dissolved metals does not change.

17. The method of claim 16, wherein
a) Fe is removed by aeration or chemical precipitation and/or
b) Al is removed by chemical precipitation at low pH, and/or
c) the rare earth elements are removed by chemical precipitation at acidic or neutral pH.

18. (canceled)

19. (canceled)

20. A method of purification or selectively removing dissolved metals from an aqueous solution, the method comprising:
a) adjusting a pH of the aqueous solution to a predetermined pH;
b) flowing ozone into the aqueous solution to achieve a predetermined oxidation-reduction potential and stirring the aqueous solution for a predetermined period of time, thereby forming a first solid metal fraction;
c) separating the first solid metal fraction; and
d) repeating steps a)-c) for a second or more solid metal fraction.

21. The method of claim 20, wherein one of the first, second or more solid metal fraction comprises the dissolved metals, wherein the dissolved metals are one or more of Co, Mn, Ni, Cu, Ag, Cd, Zr, Ce, Os, Ir, Pd, Pt, Rh, Ru, Cr, Fe, Bi, Ga, Sn, and/or Ti and/or wherein about 50-99% of metals from the first, second, or more solid metal fraction of the aqueous solution are recovered.

22. The method of claim 20, wherein the predetermined pH is in a range of about 0 to about 8.

23. The method of claim 20, wherein the aqueous solution is a brine, waste waters of mine, oil and gas industry, or a leachate obtained by processing ores, processing secondary sources, processing waste, processing sludge, processing precipitates, or recycling electronic waste, battery, and solar panel.

24. (canceled)
